(19) United States
(12) Patent Application Publication
(10) Pub. No.: US 2024/0158257 A1
(43) Pub. Date: May 16, 2024

(54) MANGANESE OXIDES AND CATHODE ACTIVE MATERIALS

(71) Applicant: Honda Motor Co., Ltd., Tokyo (JP)

(72) Inventor: Yiman ZHANG, San Jose, CA (US)

(21) Appl. No.: 17/985,756

(22) Filed: Nov. 11, 2022

(51) Int. Cl. C01G 45/02; C01G 45/00; H01M 10/0525; H01M 50/46

(52) U.S. Cl. CPC C01G 45/02; C01G 45/006; H01M 10/0525; H01M 50/46; C01P 2002/76; C01P 2006/40; H01M 2220/20

(57) ABSTRACT

Aspects of the present disclosure generally relate to battery technology, and more specifically relate to manganese oxides and cathode active materials. In an aspect, a cathode active material is provided. The cathode active material includes a composition comprising a manganese oxide represented by Formula (I): LiₐNa_{b}(M¹)_{c}Mn_{d}Oₑ, a manganese oxide represented by Formula (II): Na_{w}(M²)ₓMn_{y}O_{z} (II), or combinations thereof, wherein: each of M¹ and M² is, individually, Ni, Cu, Zn, Mg, Fe, Co, Li, Al, Cr, LiAl, LiCr, LiCo, or combinations thereof, a, b, c, d, and e represent molar ratios of respective elements in Formula (I); and w, x, y, and z represent molar ratios of respective elements in Formula (II). Batteries and articles comprising a manganese oxide described herein are provided. Processes for forming manganese oxides are also provided.

### FIELD

Aspects of the present disclosure generally relate to battery technology, and more specifically relate to manganese oxides and cathode active materials.

### BACKGROUND

Technological advancements, demands for mobile instruments, and the pursuit of reduced greenhouse gas emissions has increased demands of energy storage technologies such as lithium-ion and sodium-ion batteries. Already, lithium-ion batteries (LIBs) play a significant role in enabling the electrification of cars and buses and support the grid application. However, to make de-carbonization a reality, batteries must improve. Among the four primary components of a battery—cathode, anode, electrolyte, and separator—the cathode and cathode materials are widely recognized as the major bottleneck for improving the battery performance and decreasing the cost. Thus, pursuing the low-cost cathode material with large capacity and long cycle life are required to meet the increasing demands of battery energy storage.

Conventional cathode active materials include lithium-containing cobalt oxide (LiCoO₂), lithium-containing manganese oxides (LiMnO₂ and LiMn₂O₂), and lithium-containing nickel oxide (LiNiO₂). Although LiCoO₂ has good cycle properties, this material can have low safety and the scarcity of cobalt increases the cost of this oxide. Manganese is relatively abundant and environmentally safe. However, traditional lithium-containing manganese oxides can have low charge capacity and poor cycle properties. Traditional lithium-containing nickel oxides can exhibit rapid phase transitions during charge-discharge cycles and can exhibit excess gas generation during charge-discharge cycling and storage.

There is a need for new and improved manganese oxides and cathode active materials.

### SUMMARY

Aspects of the present disclosure generally relate to battery technology, and more specifically relate to manganese oxides and cathode active materials.

In an aspect, a cathode active material is provided. The cathode active material includes a composition comprising:
a manganese oxide represented by Formula (I):

LiₐNa_{b}(M¹)_{c}Mn_{d}Oₑ,
a manganese oxide represented by Formula (II):

Na_{w}(M²)ₓMn_{y}O_{z} (II),
or combinations thereof, wherein:
   each of M¹ and M² is, individually, Ni, Cu, Zn, Mg, Fe, Co, Li, Al, Cr, LiAl, LiCr, LiCo, or combinations thereof,
   a, b, c, d, and e represent molar ratios of respective elements in Formula (I); and
   w, x, y, and z represent molar ratios of respective elements in Formula (II).

In another aspect, a battery is provided. The battery includes a cathode comprising a manganese oxide described herein.

In another aspect, an article is provided. The article includes a device and a battery electrically coupled to the device, the battery comprising a manganese oxide described herein.

In another aspect, a process for forming a manganese oxide is provided. The process includes introducing a sodium-containing precursor with a manganese-containing precursor and a metal-containing precursor under first conditions to form a mixture, the metal-containing precursor being different from the sodium-containing precursor and the manganese-containing precursor, the metal-containing precursor comprising Ni, Cu, Zn, Mg, Fe, Co, Li, Al, Cr, LiAl, LiCr, LiCo, or combinations thereof. The process further includes heating the mixture under second conditions to form a composition comprising a manganese oxide represented by Formula (II):

Na_{w}(M²)ₓMn_{y}O_{z} (II),
wherein, in Formula (II):
   M² is Ni, Cu, Zn, Mg, Fe, Co, Li, Al, Cr, LiAl, LiCr, LiCo, or combinations thereof, and
   w, x, y, and z represent molar ratios of the respective elements.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1A is a flowchart showing selected operations of a process for producing a sodium-containing manganese oxide according to at least one aspect of the present disclosure.

FIG. 1B is a flowchart showing selected operations of a process for producing a lithium-containing manganese oxide according to at least one aspect of the present disclosure.

FIG. 1C is a general reaction diagram for forming sodium-containing manganese oxides and lithium-containing manganese oxides according to at least one aspect of the present disclosure.

FIG. 2 is an exploded perspective view of an example battery according to at least one aspect of the present disclosure.

FIG. 3 shows exemplary powder x-ray diffraction (PXRD) patterns of example lithium-containing manganese oxides formed from an example P3-type sodium-containing manganese oxide (Na_{2/3}Ni_{1/3}Mn_{2/3}O₂) at various temperatures according to at least one aspect of the present disclosure.

FIG. 4A shows exemplary PXRD patterns of an example P3-type sodium-containing manganese oxide (Na_{2/3}(LiAl)_{1/6}Mn_{2/3}O₂) and a lithium-containing manganese oxide formed after one ion-exchange reaction according to at least one aspect of the present disclosure.

FIG. 4B shows exemplary PXRD patterns of an example P3-type sodium-containing manganese oxide (Na_{2/3}Cu_{1/3}Mn_{2/3}O₂) and an example lithium-containing manganese oxide formed after one ion-exchange reaction according to at least one aspect of the present disclosure.

FIG. 5A shows exemplary PXRD patterns of example lithium-containing manganese oxides formed by ion exchange reactions from an example P2-type sodium-containing manganese oxide (Na_{2/3}Ni_{1/3}Mn_{2/3}O₂) according to at least one aspect of the present disclosure.

FIG. 5B shows exemplary PXRD patterns of example lithium-containing manganese oxides formed by ion exchange reactions from an example P2-type sodium-containing manganese oxide (Na_{2/3}(LiAl)_{1/6}Mn_{2/3}O₂) according to at least one aspect of the present disclosure.

FIGS. 6A-6D shows example galvanostatic charge and discharge curves for example lithium-containing manganese oxides according to at least one aspect of the present disclosure.

### DETAILED DESCRIPTION

Aspects of the present disclosure generally relate to battery technology, and more specifically relate to manganese oxides and cathode active materials. The manganese oxides and cathode active materials described herein can be used in, for example, lithium-ion batteries and sodium-ion batteries.

The manganese oxides can be layered manganese oxides. As described herein, the inventor has discovered lithium-containing manganese oxides and sodium-containing manganese oxides that can be used as cathode active materials. As described herein, P3-type phases and P2-type phases of sodium-containing manganese oxides can be synthesized using a solid state reaction. The lithium-containing manganese oxides can be synthesized by submitting the P3-type phases and P2-type phases of sodium-containing manganese oxides to an ion exchange reaction. The ion exchange reaction can be conducted in, for example, solvent and solid-state reaction, with, for example, lithium bromide (LiBr) or lithium hexafluorophosphate (LiPF₆) salts, among other lithium salts. As further described below, the inventor also found that the temperature of the ion exchange reaction as well as the metal (M) can affect the structure of the lithium-containing manganese oxide product, which in turn, can affect the electrochemical performance. Moreover, the lithium-containing manganese oxides and sodium-containing manganese oxides described herein can be free of cobalt, thereby decreasing the production costs of cathode active materials.

### Example Manganese Oxides and Cathode Active Materials

Aspects of the present disclosure generally relate to manganese oxides that can be used as at least a portion of a cathode active material. Manganese oxides described herein can be layered manganese oxides. The manganese oxides can contain lithium and/or sodium. In some aspects, lithium-containing manganese oxides are represented by Formula (I):

LiₐNa_{b}(M¹)_{c}Mn_{d}Oₑ (I)

In Formula (I), M¹ is a metal or more than one metal. For example, M¹ in Formula (I) can be any suitable metal(s) such as nickel (Ni), copper (Cu), zinc (Zn), magnesium (Mg), iron (Fe), cobalt (Co), lithium (Li), aluminum (Al), chromium (Cr), lithium aluminum (LiAl), lithium chromium (LiCr), lithium cobalt (LiCo), or combinations thereof, at any suitable oxidation state such as Ni²⁺, Cu²⁺, Zn²⁺, Mg²⁺, Fe²⁺, CO₂₊, Co³⁺, Li, Al³⁺, Cr³⁺, Fe³⁺, Li⁺Al³⁺, Li⁺Cr³⁺, Li+Co³⁺, or combinations thereof. Different oxidation states of the metal(s) are contemplated.

In Formula (I), a is the amount of lithium (Li), b is the amount of sodium (Na), c is the amount of metal (M¹), dis the amount of manganese (Mn), and e is the amount of oxygen (O).

In some aspects, a of Formula (I) can be about 0.6 or more and/or about 0.8 or less, such as from about 0.6 to about 0.8, such as from about 0.65 to about 0.75, such as from about 0.65 to about 0.7, or from about 0.7 to about 0.75. In at least one aspect, a of Formula (I) can be 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, or 0.8, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, b of Formula (I) can be about 0 or more and/or about 0.07 or less, such as from about 0 to about 0.07, such as from about 0.0006 to about 0.07, such as from about 0.01 to about 0.06, such as from about 0.02 to about 0.05, such as from about 0.03 to about 0.04. In at least one aspect, b of Formula (I) can be 0, 0.01, 0.02, 0.03, 0.0.4, 0.05, 0.06, or 0.07, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, c of Formula (I) can be about 0.33 or more and/or about 0.4 or less, such as from about 0.33 to about 0.4, such as from about 0.34 to about 0.39, such as from about 0.35 to about 0.38, or from about 0.36 to about 0.37. In at least one aspect, c of Formula (I) can be 0.33, 0.34, 0.35, 0.36, 0.37, 0.38, 0.39, or 0.4, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, d of Formula (I) can be about 0.6 or more and/or about 0.67 or less, such as from about 0.6 to about 0.67, such as from about 0.61 to about 0.66, such as from about 0.62 to about 0.65, or from about 0.63 to about 0.64. In at least one aspect, d of Formula (I) can be 0.6, 0.61, 0.62, 0.63, 0.64, 0.65, 0.66, or 0.67, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, e of Formula (I) can be about 1.95 or more and/or about 2.05 or less, such as from about 1.95 to about 2.05, such as from about 1.96 to about 2.04, such as from about 1.97 to about 2.03, such as from about 1.98 to about 2.02, such as from about 1.99 to about 2.01. In at least one aspect, e of Formula (I) can be 1.95, 1.96, 1.97, 1.98, 1.99, 2, 2.01, 2.02, 2.03, 2.04, or 2.05, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of a:b of Formula (I) can be about 80:1 to about 8:1, such as from about 70:1 to about 10:1, such as from about 50:1 to about 20:1. In at least one aspect, the molar ratio of a:b in Formula (I) can be derived from the amount of a and the amount of b described above. In at least one aspect, a molar ratio of a:b of Formula (I) can be 80:1, 75:1, 70:1, 65:1, 60:1, 55:1, 50:1, 45:1, 40:1, 35:1, 30:1, 25:1, 20:1, 15:1, 10:1, 9:1, or 8:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of a:c of Formula (I) can be about 2.4:1 to about 1.5:1, such as from about 2.2:1 to about 1.6:1, such as from about 2:1 to about 1.8:1. In at least one aspect, the molar ratio of a:b in Formula (I) can be derived from the amount of a and the amount of c described above. In at least one aspect, a molar ratio of a:c of Formula (I) can be 2.4:1, 2.35:1, 2.3:1, 2.25:1, 2.2:1, 2.15:1, 2.1:1, 2.05:1, 2:1, 1.95:1, 1.9:1, 1.85:1, 1.8:1, 1.75:1, 1.7:1, 1.65:1, 1.6:1, 1.55:1, or 1.5:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of a:d of Formula (I) can be about 1.3:1 to about 0.9:1, such as from about 1.2:1 to about 1:1, such as from about 1.1:1 to about 1:1. In at least one aspect, the molar ratio of a:d in Formula (I) can be derived from the amount of a and the amount of d described above. In at least one aspect, a molar ratio of a:d of Formula (I) can be 1.3:1, 1.25:1, 1.2:1, 1.15:1, 1.1:1, 1.05:1, 1:1, 0.95:1, or 0.9:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of a:e of Formula (I) can be about 0.29:1 to about 0.41:1, such as from about 0.3:1 to about 0.4:1, such as from about 0.35:1 to about 0.4:1. In at least one aspect, the molar ratio of a:e in Formula (I) can be derived from the amount of a and the amount of e described above. In at least one aspect, a molar ratio of a:e of Formula (I) can be 0.29:1, 0.3:1, 0.31:1, 0.32:1, 0.33:1, 0.34:1, 0.35:1, 0.36:1, 0.37:1, 0.38:1, 0.39:1, 0.4:1, or 0.41:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of b:c of Formula (I) can be about 0.02:1 to about 0.21:1, such as from about 0.05:1 to about 0.2:1, such as from about 0.1:1 to about 0.15:1. In at least one aspect, the molar ratio of b:c in Formula (I) can be derived from the amount of b and the amount of c described above. In at least one aspect, a molar ratio of b:c of Formula (I) can be 0.02:1, 0.03:1, 0.04:1, 0.05:1, 0.06:1, 0.07:1, 0.08:1, 0.09:1, 0.1:1, 0.11:1, 0.12:1, 0.13:1, 0.14:1, 0.15:1, 0.16:1, 0.17:1, 0.18:1, 0.19:1, 0.2:1, or 0.21:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of b:d of Formula (I) can be about 0.01:1 to about 0.12:1, such as from about 0.03:1 to about 0.1:1, such as from about 0.05:1 to about 0.08:1. In at least one aspect, the molar ratio of b:d in Formula (I) can be derived from the amount of b and the amount of d described above. In at least one aspect, a molar ratio of b:d of Formula (I) can be 0.01:1, 0.02:1, 0.03:1, 0.04:1, 0.05:1, 0.06:1, 0.07:1, 0.08:1, 0.09:1, 0.1:1, 0.11:1, or 0.12:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of b:e of Formula (I) can be about 0.005:1 to about 0.35:1, such as from about 0.01:1 to about 0.3:1, such as from about 0.015:1 to about 0.025:1. In at least one aspect, the molar ratio of b:e in Formula (I) can be derived from the amount of b and the amount of e described above. In at least one aspect, a molar ratio of b:e of Formula (I) can be 0.005:1, 0.006:1, 0.007:1, 0.008:1, 0.009:1, 0.01:1, 0.011:1, 0.012:1, 0.013:1, 0.014:1, 0.015:1, 0.016:1, 0.017:1, 0.018:1, 0.019:1, 0.02:1, or 0.021:1, 0.022:1, 0.023:1, 0.024:1, 0.025:1, 0.026:1, 0.027:1, 0.028:1, 0.029:1, 0.03:1, 0.031:1, 0.032:1, 0.033:1, 0.034:1, or 0.035:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of c:d of Formula (I) can be about 0.49:1 to about 0.67:1, such as from about 0.5:1 to about 0.65:1, such as from about 0.55:1 to about 0.6:1. In at least one aspect, the molar ratio of c:d in Formula (I) can be derived from the amount of c and the amount of d described above. In at least one aspect, a molar ratio of c:d of Formula (I) can be 0.49:1, 0.5:1, 0.51:1, 0.52:1, 0.53:1, 0.54:1, 0.55:1, 0.56:1, 0.57:1, 0.58:1, 0.59:1, 0.6:1, or 0.61:1, 0.62:1, 0.63:1, 0.64:1, 0.65:1, 0.66:1, 0.67:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of c:e of Formula (I) can be about 0.16:1 to about 0.21:1, such as from about 0.17:1 to about 0.2:1, such as from about 0.18:1 to about 0.19:1. In at least one aspect, the molar ratio of c:e in Formula (I) can be derived from the amount of c and the amount of e described above. In at least one aspect, a molar ratio of c:e of Formula (I) can be 0.16:1, 0.165:1, 0.17:1, 0.175:1, 0.18:1, 0.185:1, 0.19:1, 0.195:1, 0.2:1, 0.205:1, or 0.21:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of d:e of Formula (I) can be about 0.29:1 to about 0.35:1, such as from about 0.3:1 to about 0.34:1, such as from about 0.32:1 to about 0.33:1. In at least one aspect, the molar ratio of d:e in Formula (I) can be derived from the amount of d and the amount of e described above. In at least one aspect, a molar ratio of d.e of Formula (I) can be 0.29:1, 0.295:1, 0.3:1, 0.305:1, 0.305:1, 0.31:1, 0.315:1, 0.32:1, 0.325:1, 0.33:1, 0.335:1, 0.34:1, 0.345:1, or 0.35:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

For the lithium-containing manganese oxide of Formula (I), the amounts of a, b, c, d, and e, and the molar ratios of a:b, a:c, a:d, a:e, b:c, b:d, b:e, c:d, c:e, and d.e are determined by inductively coupled plasma optical emission spectroscopy (ICP-OES) of the lithium-containing manganese oxide being analyzed. The ICP-OES is described in the Examples Section.

For processes for producing a lithium-containing manganese oxide of Formula (I), the amounts of a, b, c, d, and e, and the molar ratios of a:b, a:c, a:d, a:e, b:c, b:d, b:e, c:d, c:e, and d.e are determined by ICP-OES of the lithium-containing manganese oxide being analyzed, as described in the Examples Section.

In at least one aspect, a lithium-containing manganese oxide represented by Formula (I) is represented by Formula (Ia):

Li_{(2/3-n)}Naₙ(M¹)_{1/3}Mn_{2/3}O₂ (Ia),
wherein, for Formula (Ia), n is less than or equal to about 0.15 (such as less than or equal to about 0.1, such as less than or equal to about 0.05), and the metal (M¹) is described above in Formula (I).

In Formula (Ia), n can be from about 0.01 to about 0.15, such as from about 0.01 to about 0.1, such as from about 0.01 to about 0.05, such as from about 0.02 to about 0.04. In at least one aspect, n can be 0.01, 0.015, 0.02, 0.025, 0.03, 0.035, 0.04, 0.045, 0.05, 0.06, 0.07, 0.08, 0.09, 0.1, 0.11, 0.12, 0.13, 0.14, or 0.15, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, sodium-containing manganese oxides are represented by Formula (II):

Na_{w}(M²)ₓMn_{y}O_{z} (II)

In Formula (II), M² is a metal or more than one metal. For example, M² in Formula (II) can be any suitable metal(s) such as Ni, Cu, Zn, Mg, Fe, Co, Li, Al, Cr, LiAl, LiCr, LiCo, or combinations thereof, at any suitable oxidation state such as Ni²⁺, Cu²⁺, Zn²⁺, Mg²⁺, Fe²⁺, CO₂₊, Co³⁺, Li⁺, Al³⁺, Cr³⁺, Fe³⁺, Li⁺Al³⁺, Li⁺Cr³⁺, Li⁺Co³⁺, or combinations thereof. Different oxidation states of the metal(s) are contemplated.

In Formula (II), w is the amount of sodium, x is the amount of metal (M²), y is the amount of manganese, and z is the amount of oxygen.

In some aspects, w of Formula (II) can be about 0.67 or more and/or about 0.8 or less, such as from about 0.7 to about 0.8, such as from about 0.7 to about 0.75 or from about 0.75 to about 0.8. In at least one aspect, w of Formula (II) can be 0.67, 0.68, 0.69, 0.7, 0.71, 0.72, 0.73, 0.74, 0.75, 0.76, 0.77, 0.78, 0.79, or 0.8, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, x of Formula (II) can be about 0.33 or more and/or about 0.4 or less, such as from about 0.33 to about 0.4, such as from about 0.34 to about 0.39, such as from about 0.35 to about 0.38, or from about 0.36 to about 0.37. In at least one aspect, x of Formula (II) can be 0.33, 0.34, 0.35, 0.36, 0.37, 0.38, 0.39, or 0.4, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, y of Formula (II) can be about 0.6 or more and/or about 0.67 or less, such as from about 0.6 to about 0.67, such as from about 0.61 to about 0.66, such as from about 0.62 to about 0.65, or from about 0.63 to about 0.64. In at least one aspect, y of Formula (II) can be 0.6, 0.61, 0.62, 0.63, 0.64, 0.65, 0.66, or 0.67, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, z of Formula (II) can be about 1.95 or more and/or about 2.05 or less, such as from about 1.95 to about 2.05, such as from about 1.96 to about 2.04, such as from about 1.97 to about 2.03, such as from about 1.98 to about 2.02, such as from about 1.99 to about 2.01. In at least one aspect, z of Formula (II) can be 1.95, 1.96, 1.97, 1.98, 1.99, 2, 2.01, 2.02, 2.03, 2.04, or 2.05, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of w:x of Formula (II) can be about 2.4:1 to about 1.6:1, such as from about 2.2:1 to about 1.6:1, such as from about 2:1 to about 1.8:1. In at least one aspect, the molar ratio of w:x in Formula (II) can be derived from the amount of w and the amount of x described above. In at least one aspect, a molar ratio of w:x of Formula (II) can be 2.4:1, 2.35:1, 2.3:1, 2.25:1, 2.2:1, 2.15:1, 2.1:1, 2.05:1, 2:1, 1.95:1, 1.9:1, 1.85:1, 1.8:1, 1.75:1, 1.7:1, 1.65:1, or 1.6:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of w:y of Formula (II) can be about 1.3:1 to about 1:1, such as from about 1.2:1 to about 1.05:1, such as from about 1.15:1 to about 1.1:1. In at least one aspect, the molar ratio of w:y in Formula (II) can be derived from the amount of w and the amount of y described above. In at least one aspect, a molar ratio of w:y of Formula (II) can be 1.3:1, 1.25:1, 1.2:1, 1.15:1, 1.1:1, 1.05:1, or 1:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of w:z of Formula (II) can be about 0.32:1 to about 0.41:1, such as from about 0.34:1 to about 0.4:1, such as from about 0.35:1 to about 0.38:1. In at least one aspect, the molar ratio of w:z in Formula (II) can be derived from the amount of w and the amount of z described above. In at least one aspect, a molar ratio of w:z of Formula (II) can be 0.32:1, 0.33:1, 0.34:1, 0.35:1, 0.36:1, 0.37:1, 0.38:1, 0.39:1, 0.4:1, or 0.41:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A molar ratio of y:z of Formula (II) can be about 0.29:1 to about 0.35:1, such as from about 0.3:1 to about 0.34:1, such as from about 0.32:1 to about 0.33:1. In at least one aspect, the molar ratio of y:z in Formula (II) can be derived from the amount of y and the amount of z described above. In at least one aspect, a molar ratio of y:z of Formula (II) can be 0.29:1, 0.295:1, 0.3:1, 0.305:1, 0.305:1, 0.31:1, 0.315:1, 0.32:1, 0.325:1, 0.33:1, 0.335:1, 0.34:1, 0.345:1, or 0.35:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

For the sodium-containing manganese oxide of Formula (II), the amounts of w, x, y, and z, and the molar ratios of w:x, w:y, w:z, and y:z are determined by ICP-OES of the sodium-containing manganese oxide being analyzed. The ICP-OES is described in the Examples Section.

For processes for producing a sodium-containing manganese oxide of Formula (II), the amounts of w, x, y, and z, and the molar ratios of w:x, w:y, w:z, and y:z are determined by ICP-OES of the sodium-containing manganese oxide being analyzed, as described in the Examples Section.

In some aspects, a sodium-containing manganese oxide represented by Formula (II) is represented by Formula (IIa):

Na_{2/3}(M²)_{1/3}Mn_{2/3}O₂ (IIa),
wherein, for Formula (IIa), the metal (M²) is described above in Formula (II).

As described above, the lithium-containing manganese oxide represented by Formula (I) and/or the sodium-containing manganese oxide of Formula (II) of the present disclosure can be layered. Here, the layered structure of the lithium-containing manganese oxide represented by Formula (I) and/or the sodium-containing manganese oxide of Formula (II) can have a layered P2 structure, a layered P3 structure, or combinations thereof. The layered P2 structure, layered P3 structure, and combinations thereof can be determined by powder x-ray diffraction as shown in the Examples Section. “P” refers to prismatic and the numbers 2 and 3 refer to oxygen-stacking pattern. The Na⁺ resides in prismatic site, while the oxygen stacks in AABB in P2-type and AABBCC in P3-type. The oxygen stacking sequence can be adjusted by, for example, changing the temperature of one or more operations of the synthetic sequence to make the lithium-containing manganese oxide and the sodium-containing manganese oxide. In general, the P2 structure and P3 structure have different symmetries, which means different peaks will be present for the structures.

A sodium-containing manganese oxide described herein as having a P2 structure can be interchangeably referred to as a P2 phase or a P2-type manganese oxide. For example, a sodium-containing manganese oxide having a P2 structure can be interchangeably referred to as a sodium-containing manganese oxide having a P2 phase or a P2-type sodium-containing manganese oxide. A sodium-containing manganese oxide described herein as having a P3 structure can be interchangeably referred to as a P3 phase or a P3-type manganese oxide. For example, a sodium-containing manganese oxide having a P3 structure can be interchangeably referred to as a sodium-containing manganese oxide having a P3 phase or a P3-type sodium-containing manganese oxide.

While not wishing to be bound by theory, after ion exchange, the Li+ ions go between the oxygen layers to form octahedral (O) or tetragonal (T) geometry which will result in 0 phase or T phase. The oxygen stacking pattern is AABBCC in the O3/T3 phase or AABB in the O2/T2 phase. O3/T3 phase refers to O3 or T3 phase, and O2/T2 refers to the O2 or T2 phase.

A lithium-containing manganese oxide described herein as having a O2/T2 structure can be interchangeably referred to as a lithium-containing manganese oxide having a O2/T2 phase or a O2/T2-type manganese oxide. A lithium-containing manganese oxide described herein as having a O3/T3 structure can be interchangeably referred to as a lithium-containing manganese oxide having a O3/T3 phase or a O3/T3-type manganese oxide.

Manganese oxides described herein may be in any suitable form such as a crystal, powder, or particle. An average particle diameter of the manganese oxide particles can be from about 1 nm to about 100 μm, or any number or subrange in between. In some examples, an average particle diameter of the manganese oxide particles can be from about 0.01 μm to about 60 μm, such as from about 0.01 μm to about 0.1 μm, or from about 0.1 μm to about 1 μm, or from about 1 μm to about 20 μm, or from about 20 μm to about 40 μm, or from about 40 μm to about 60 μm though other average particle diameters are contemplated. In a non-limiting example, the lithium metal oxide particles have an average particle size of about 1 μm to about 10 μm. Average particle diameter is determined by scanning electron microscope (SEM) as described in the Examples Section.

In some non-limiting examples, diffraction peaks in a powder x-ray diffraction spectrum of example manganese oxides described herein can be characterized as one or more of the following:
(a) A P2-type sodium-containing manganese oxide has a diffraction peak at 15.96°±0.1°, 32.15°±0.1°, 36.00°±0.1°, 39.57°±0.1°, 43.73°±0.1°, 48.99°±0.1°, 62.35°±0.1°, 64.60°±0.1°, 67.09°±0.1°, 78.46°±0.1°, 73.96°±0.1°, or combinations thereof
(b) An O2/T2-type lithium-containing manganese oxide has a diffraction peak at 18.65°±0.1°, 36.89°±0.1°, 37.25°±0.1°, 43.36°±0.1°, 44.56°±0.1°, or combinations thereof.
(c) A P3-type sodium-containing manganese oxide has a diffraction peak at 15.89°±0.1°, 32.01°±0.1°, 36.42°±0.1°, 37.61°±0.1°, 43.36°±0.1°, 45.27°±0.1°, 52.94°±0.1°, 57.38°±0.1°, 62.93°±0.1°, 64.66°±0.1°, 67.11°±0.10, or combinations thereof.
(d) An O3/T3-type lithium-containing manganese oxide at about room temperature has a diffraction peak at 18.31°±0.1°, 36.72°±0.1°, 44.20°±0.1°, 58.00°±0.1°, 63.33°±0.1°, 65.03°±0.1°, 68.17°±0.1°, or combinations thereof.
(e) An O3/T3-type lithium-containing manganese oxide at about 80° C. has a diffraction peak at 18.39°±0.1°, 36.82°±0.1°, 43.38°±0.1°, 44.28°±0.1°, 48.23°±0.1°, 58.03°±0.1°, 65.09°±0.1°, or combinations thereof.
(f) An O3/T3-type lithium-containing manganese oxide at about 130° C. has a diffraction peak at 18.39°±0.1°, 36.70°±0.1°, 44.20°±0.1°, 57.93°±0.1°, 62.97°±0.1°, 63.60°±0.1°, 65.05°±0.1°, 68.13°±0.1°, or combinations thereof.
(g) An O3/T3-type lithium-containing manganese oxide at about 200° C. has a diffraction peak at 18.60°±0.1°, 36.79°±0.1°, 43.42°±0.1°, 44.46°±0.1°, 58.56°±0.1°, 65.23°±0.1°, or combinations thereof.
(h) An O3/T3-type lithium-containing manganese oxide at about 250° C. has a diffraction peak at 18.67°±0.1°, 36.82°±0.1°, 43.40°±0.1°, 44.51°±0.1°, 58.66°±0.1°, 65.27°±0.1°, or combinations thereof.
(i) An O3/T3-type lithium-containing manganese oxide at about 330° C. has a diffraction peak at 18.67°±0.1°, 36.86°±0.1°, 37.27°±0.1°, 43.35°±0.1°, 44.53°±0.1°, 58.68°±0.1°, 63.01°±0.1°, 64.78°±0.1°, or combinations thereof.
(j) A P3-type Na_{2/3}Cu_{1/3}Mn_{2/3}O₂ has a diffraction peak at 18.39°±0.1°, 36.70°±0.1°, 44.20°±0.1°, 57.93°±0.1°, 62.97°±0.1°, 63.60°±0.1°, 65.05°±0.1°, 68.13°±0.1°, or combinations thereof.
(k) An O3/T3-type lithium-containing analogue of (j) has a diffraction peak at 18.71°±0.1°, 32.11°±0.1°, 36.09°±0.1°, 36.51°±0.1°, 37.16°±0.1°, 37.61°±0.1°, 38.87°±0.1°, 44.48°±0.1°, 45.51°±0.10, or combinations thereof.
(l) A P3-type Na_{2/3}Li_{1/6}Al_{1/6}Mn_{2/3}O₂ has a diffraction peak at 16.03°±0.1°, 32.30°±0.1°, 36.82°±0.1°, 38.06°±0.1°, 38.24°±0.1°, 45.46°±0.1°, 45.82°±0.1°, 46.10°±0.1°, 53.10°±0.1°, 57.98°±0.1°, 65.49°±0.1°, 67.71°±0.1°, or combinations thereof.
(m) An O3/T3-type lithium-containing analogue of (1) has a diffraction peak at 18.70°±0.1°, 36.99°±0.1°, 44.64°±0.1°, 58.75°±0.1°, 64.56°±0.1°, 65.62°±0.1°, 68.89°±0.10, or combinations thereof.
(n) A P2-type Na_{2/3}Li_{1/6}Al_{1/6}Mn_{2/3}O₂ has a diffraction peak at 15.95°±0.1°, 32.18°±0.1°, 36.37±0.1°, 39.94°±0.1°, 44.06°±0.1°, 49.31°±0.1°, 65.43°±0.1°, or combinations thereof.
(o) An O2/T2-type lithium-containing analogue of (n) has a diffraction peak at 18.76°±0.1°, 37.16°±0.1°, 44.84°±0.1°, 65.72°±0.1°, or combinations thereof.

The manganese oxide may be in the form of a composite, for example, a composite manganese oxide. Manganese oxides described herein can be utilized as cathode active materials. Accordingly, and in some aspects, a cathode active material includes at least one manganese oxide, such as at least one lithium-containing manganese oxide represented by Formula (I), at least one sodium-containing manganese oxide represented by Formula (II), or combinations thereof. The cathode active material may be in the form of a composition. As used herein, a “composition” can include component(s) of the composition, reaction product(s) of two or more components of the composition, a remainder balance of remaining starting component(s), or combinations thereof. Compositions of the present disclosure can be prepared by any suitable mixing process.

The manganese oxide described herein (e.g., as a cathode active material) can be used in energy storage devices such as batteries, including secondary batteries, as further described below. The manganese oxides described herein can increase the capacity of the battery, the voltage of the battery, among other electrochemical performance properties. Relative to conventional cathode active materials, manganese oxides of the present disclosure can have improved battery cycle life, increased charge capacity, good cycle properties, and enhanced overall stability. Further, manganese oxides of the present disclosure can achieve a better overall balance of electrochemical performance properties, for example an improved balance of the aforementioned properties. Moreover, the manganese oxides can be produced cost-effectively than traditional technologies such as those containing cobalt.

### Example Cathodes

Aspects of the present disclosure also generally relate to cathodes. The cathode can include at least one cathode active material (e.g., at least one manganese oxide) and one or more additional components. The one or more additional components can include a conductive agent and a binder. Illustrative, but non-limiting, examples of conductive agents can include carbon black, acetylene black, lamp black, summer black, ketchen black, furnace black, channel black, carbon fiber, natural graphite, artificial graphite, or combinations thereof, among other suitable conductive agents. Illustrative, but non-limiting, examples of binders can include polyvinylidene fluoride (PVDF), tetrafluoroethylene, fluorine rubber, polyethylene, polypropylene, polyvinyl alcohol, high saponification polyvinyl alcohol, carboxymethyl cellulose (CMC), starch, hydroxypropyl cellulose, regenerated cellulose, polyvinyl pyrrolidone, ethylene-propylene-diene terpolymer (EPDM), sulfonated EPDM, styrene-butylene rubber, different copolymers, or combinations thereof, among other suitable conductive agents.

The cathode can be in the form of a composition. The cathode can include various amounts or weight ratios of the one or more cathode active materials, the one or more conductive agents, and the one or more binders. In some aspects, a total amount of cathode active material in a cathode composition described herein can be about 40 wt % or more and/or about 99 wt % or less, such as from about 45 wt % to about 98 wt %, such as from about 50 wt % to about 95 wt %, such as from about 60 wt % to about 90 wt %, such as from about 70 wt % to about 85 wt %, such as from about 75 wt % to about 80 wt %, based on a total weight of the cathode composition. The total weight of the cathode composition is based on the sum of the weight of the cathode active material, the conductive agent, and the binder. In at least one aspect, a total amount (in wt %) of cathode active material in a cathode composition can be 40, 45, 50, 55, 60, 65, 70, 75, 76, 77, 78, 79, 80, 81, 82, 83, 84, 85, 86, 87, 88, 89, 90, 91, 92, 93, 94, 95, 96, 97, 98, or 99, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, a total amount of the one or more conductive agents in a cathode composition described herein can be about 1 wt % or more and/or about 30 wt % or less, such as from about 2 wt % to about 25 wt %, such as from about 5 wt % to about 25 wt % or from about 3 wt % to about 10 wt %, based on a total weight of the cathode composition. In at least one aspect, a total amount (in wt %) of conductive agent in a cathode composition can be 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, a total amount of the one or more binders in a cathode composition described herein can be about 0 wt % or more and/or about 30 wt % or less, such as from about 1 wt % to about 25 wt %, such as from about 2 wt % to about 15 wt %, such as from about 3 wt % to about 10 wt %, based on a total weight of the cathode composition. In at least one aspect, a total amount (in wt %) of conductive material in a cathode composition can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A weight ratio of the cathode active material to the conductive agent in a cathode composition can be from about 2:1 to about 8:1, such as from about 2:1 to about 4:1, from about 4:1 to about 6:1, or from about 6:1 to about 8:1. In at least one aspect, a weight ratio of the cathode active material to the conductive agent in a cathode composition can be 2:1, 3:1, 4:1, 5:1, 6:1, 7:1, or 8:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some examples, a weight ratio of the cathode active material to the binder in a cathode composition can be from about 2:1 to about 8:1, such as from about 2:1 to about 4:1, from about 4:1 to about 6:1, or from about 6:1 to about 8:1. In at least one aspect, a weight ratio the cathode active material to the binder in a cathode composition can be 2:1, 3:1, 4:1, 5:1, 6:1, 7:1, or 8:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some examples, a weight ratio of the conductive agent to the binder in a cathode composition can be from about 3:1 to about 1:3, such as from about 3:1 to about 2:1, from about 2:1 to about 1:1, from about 1:1 to about 1:2, or from about 1:2 to about 1:3. In at least one aspect, a weight ratio of the conductive agent to the binder in a cathode composition can be 2:1, 3:1, 2:1, 1:1, 1:2, or 1:3, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, a weight ratio of the cathode active material to conductive agent to binder can be 6:4:0, 7:2.5:0.5, 8:1:1, or 9:0.5:0.5, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

A cathode can be manufactured by mixing the one or more cathode active materials, the one or more conductive agent, and the one or more binders, and then applying the mixture to a current collector such as a foil (e.g., aluminum foil). Optionally, a solvent such as N-methyl-2-pyrrolidone (NMP), N,N-dimethylformamide (DMF), dimethyl sulfoxide (DMSO), tetrahydrofuran (THF), acetone, acetonitrile, ethanol, methanol, butanol, hexanol, propanol, and combinations thereof can be used to aid in mixing. When a solvent is used, a slurry of the cathode composition can be applied to the foil to form a coating on the foil. The coating can be dried at suitable temperatures (with or without vacuum) to evaporate solvent. Alternatively, the cathode composition may be cast on a separate support to form a film, and then laminating the film on the aluminum foil. The cathode can be shaped into any suitable shape.

### Example Processes

Aspects described herein also relate to processes for producing manganese oxides such as lithium-containing manganese oxides represented by Formula (I) and sodium-containing manganese oxides represented by Formula (II).

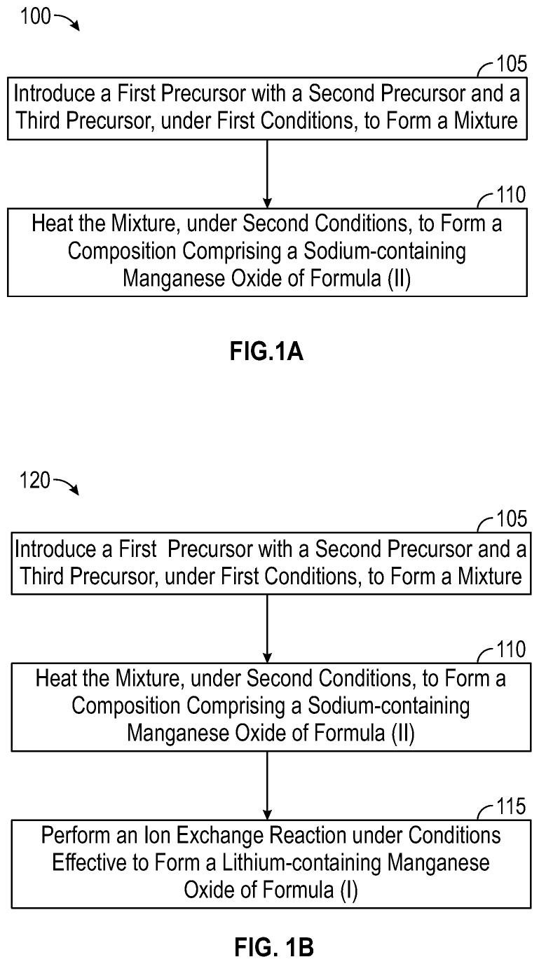

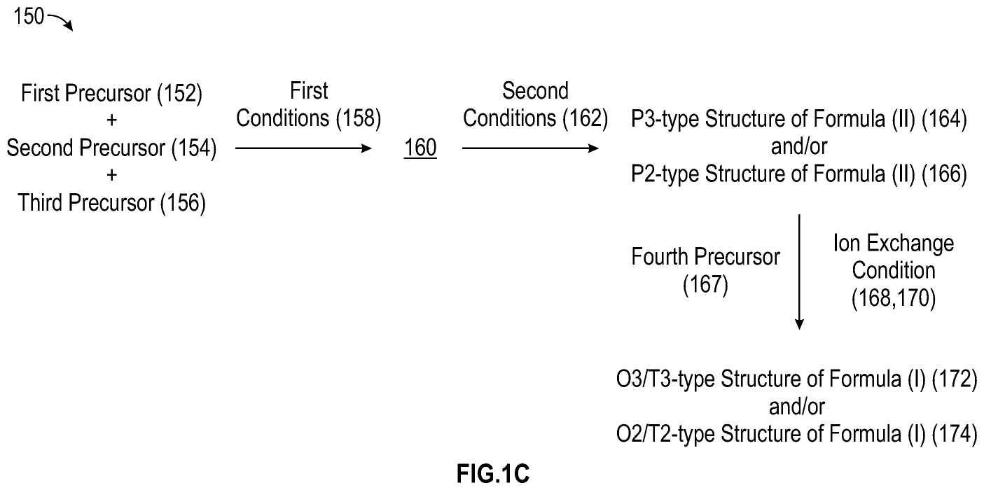

FIG. 1A is a flowchart showing selected operations of a process 100 for producing a sodium-containing manganese oxide according to at least one aspect of the present disclosure. FIG. 1B is a flowchart showing selected operations of a process 120 for producing a lithium-containing manganese oxide according to at least one aspect of the present disclosure. The operations shown in FIGS. 1A and 1B are solely for illustrative purposes and are non-limiting. FIG. 1C is an example, but non-limiting, general reaction diagram 150 for forming sodium-containing manganese oxides and lithium-containing manganese oxides according to at least one aspect of the present disclosure.

The process 100 includes introducing a first precursor 152 with a second precursor 154 and a third precursor 156, under first conditions 158, to form a mixture 160 at operation 105. Operation 105 is referred to as an initial heating operation or an initial decomposition operation. The first conditions 158 of operation 105 can include an operating temperature and an operating time. The operating temperature of operation 105 can be about 300° C. or more, such as about 350° C. or more, such as about 400° C. or more and/or about 500° C. or less, such as from about 420° C. to about 480° C., such as from about 440° C. to about 460° C. In some examples, the operating temperature (° C.) of operation 105 can be 300, 310, 320, 330, 340, 350, 360, 370, 380, 390, 400, 410, 420, 430, 440, 450, 460, 470, 480, 490, or 500, though higher or lower temperatures are contemplated. Each of the foregoing numbers can be preceded by the word “about,” “at least about,” “less than about,” or “more than about,” and any of the foregoing numbers can be used singly to describe an open-ended range or in combination to describe a close-ended range. The operating time for operation 105 can be about 5 h or more, such as about 10 h or more, such as from about 10 h to about 30 h, such as from about 12 h to about 25 h, such as from about 15 h to about 20 h, though greater or lesser operating times are contemplated. The first conditions 158 of operation 105 can include pulverizing or grinding the first precursor, the second precursor, and/or third precursor, prior to, during, and/or after introducing the first precursor with the second precursor and the third precursor. Pulverizing or grinding can be performed by, for example, a mortar and pestle, though other suitable equipment can be utilized.

The first conditions 158 of operation 105 can include stirring, mixing, and/or agitating the mixture to ensure, for example, homogeneity of the mixture. Operation 105 can be performed in the presence of air or in an oxidizing atmosphere. Additionally, or alternatively, operation 105 can be performed using a non-reactive gas (such as N₂ and/or Ar). The first conditions 158 of operation 105 can include suitable operating pressures such as from 0.75 atm (75 kPa) to 1.5 atm (150 kPa), such as from 0.9 (90 kPa) to 1.1 atm (110 kPa), such as 1 atm (101 kPa), though other operating pressures are contemplated. Each of the foregoing numbers can be preceded by the word “about,” “at least about,” “less than about,” or “more than about,” and any of the foregoing numbers can be used singly to describe an open-ended range or in combination to describe a close-ended range. After a suitable time, operation 105 can be stopped and the product cooled

The first precursor 152 is a sodium-containing precursor such as a compound having sodium and a counterion, where the counterion is, for example, nitrate (NO₃⁻), acetate (CH₃CO₂⁻), hydroxide (OH⁻), oxide (O₂⁻), carbonate (CO₃²⁻), formate (HCO₂⁻), acetylacetonate (O₂C₅H₇⁻), hydride (H⁻), SCN⁻, NO₂⁻, N₃⁻, oxalate (C₂O₄²⁻), CN⁻, OCN⁻, CNO⁻, NH₂⁻, NH²⁻, NC⁻, NCS⁻, N(CN)₂⁻, or combinations thereof. Hydrates of the first precursor 152 are also contemplated. Illustrative, but non-limiting, examples of the first precursor 152 include sodium nitrate (NaNO₃), sodium acetate (CH₃COONa), sodium carbonate (Na₂CO₃), sodium hydroxide (NaOH), sodium oxide (Na₂O), sodium peroxide (Na₂O₂), sodium formate (HCOONa), hydrates thereof (e.g., CH₃COONa·3H₂O), or combinations thereof, though other sodium-containing precursors are contemplated.

The second precursor 154 is a manganese-containing precursor such as a compound having manganese and a counterion, where the counterion is, for example, NO₃⁻, CH₃CO₂⁻, OH⁻, O₂⁻, CO₃²⁻, HCO₂⁻, O₂C₅H₇⁻, H⁻, SCN⁻, NO₂⁻, N₃⁻, C₂O₄²⁻, CN⁻, OCN⁻, CNO⁻, NH₂⁻, NH²⁻, NC⁻, NCS⁻, N(CN)₂⁻, or combinations thereof. Hydrates of the second precursor 154 are also contemplated. Illustrative, but non-limiting, examples of the second precursor 154 include manganese carbonate (MnCO₃), manganese acetate (Mn(O₂CCH₃)₃), manganese(II) oxide (MnO), manganese(III) oxide (Mn₂O₃), trimanganese tetroxide (Mn₃O₄), manganese dioxide (MnO₂), managense hydroxide (Mn(OH)₂), and manganese oxohydroxide (MnOOH), manganese nitrate Mn(NO₃)₂, hydrates thereof, or combinations thereof, though other manganese-containing precursors are contemplated.

The third precursor 156 is a metal-containing precursor, where the metal of the metal-containing precursor is the metal (M¹) of Formula (I) or the metal (M²) of Formula (II). The third precursor 156 can further include a counterion, where the counterion is, for example, NO₃⁻, CH₃CO₂⁻, OH⁻, O₂, CO₃²⁻, HCO₂⁻, O₂C₅H₇⁻, H⁻, SCN⁻, NO₂⁻, N₃⁻, C₂O₄²⁻, CN⁻, OCN⁻, CNO⁻, NH₂⁻, NH²⁻, NC⁻, NCS⁻, N(CN)₂⁻, or combinations thereof. Hydrates of the third precursor 156 are also contemplated. Suitable metal-containing precursors useful as the third precursor 156 can include, but are not limited to, metal hydroxides (M′(OH)_{f}), metal nitrates (M″(NO₃)_{g}), metal oxides (M₂Oₕ) (where M is M′ and M″), metal acetates (M(OAc)ᵢ) (where M is M′ and M″), hydrates thereof, or combinations thereof, wherein each of M′ and M″ are, individually, a metal such as those metals M¹ and M² described above; and each of f g, h, and i, are, individually, selected from 1, 2, or 3. Each off g, h, and i depend on the metal of the metal-containing precursor.

Metal hydroxides useful as the third precursor 156 can include lithium hydroxide (M′ is Li) such as LiOH; aluminum hydroxide (M′ is Al) such as Al(OH)₃; magnesium hydroxide (M′ is Mg) such as Mg(OH)₂; hydrates thereof; or combinations thereof. Metal nitrates useful as the third precursor 156 can include nickel nitrate (M″ is Ni) such as Ni(NO₃)₂; copper nitrate (M″ is Cu) such as Cu(NO₃)₂; zinc nitrate (M″ is Zn) such as Zn(NO₃)₂; magnesium nitrate (M″ is Mg) such as Mg(NO₃)₂; iron nitrate (M″ is Fe) such as Fe(NO₃)₃; cobalt nitrate (M″ is Co) such as Co(NO₃)₂; chromium nitrate (M″ is Cr) such as Cr(NO₃)₃; hydrates thereof; or combinations thereof.

When the magnesium oxide represented by Formula (I), Formula (II), or both includes a bimetallic species as M¹ or M² (for example, Li⁺Al³⁺, LiCr, or LiCo), suitable metal hydroxides include those described above for the third precursor 156. For example, lithium hydroxide (M′ is Li) such as LiOH, aluminum hydroxide (M′ is Al) such as Al(OH)₃, or both, can be used. Cobalt and chromium species, including hydrates, as described above, can also be used. Combinations of precursors can be used. For such bimetallic species, the atomic ratios are adjusted to match the site occupancy and charge neutrality in the desired product material. For example, in the case of Ni²⁺, Ni²⁺ is stoichiometric 1/3, while in the case of Li⁺Al³⁺, Li⁺ and Al³⁺ are both 1/6.

In some aspects, a molar ratio of first precursor 152 to second precursor 154 is from about 1:1 to about 1.1:1, such as from about 1:1 to about 1.05:1, or from about 1:1.1 to about 1:1, such as from about 1.05:1 to about 1.1:1.0 or from about 1:1 to about 1.05:1. In at least one aspect, a molar ratio of first precursor 152 to second precursor 154 can be 1:1.1, 1:1.05, 1:1, 1.05:1, or 1.1:1 or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range. The molar ratio of first precursor 152 to second precursor 154 is based on the starting material molar ratio used for the reaction.

In some aspects, a molar ratio of first precursor 152 to third precursor 156 is from about 2:1 to about 2.1:1, such as from about 2:1 to about 2.05:1 or from about 2.05:1.0 to about 2.1:1.0. In at least one aspect, a molar ratio of first precursor 152 to third precursor 156 can be 2:1, 2.1:1, or 2.05:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range. The molar ratio of first precursor 152 to third precursor 156 is based on the starting material molar ratio used for the reaction.

In some aspects, a molar ratio of second precursor 154 to third precursor 156 is from about 2:1 to about 2.1:1, such as from about 2:1 to about 2.05:1 or from about 2.05:1 to about 2.1:1 to about 2.1:1.0. In at least one aspect, a molar ratio of second precursor 154 to third precursor 156 can be 2:1, 2.1:1, or 2.05:1, or ranges thereof, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range. The molar ratio of second precursor 154 to third precursor 156 is based on the starting material molar ratio used for the reaction.

Process 100 further includes heating the mixture 160, under second conditions 162, to form a composition comprising a sodium-containing manganese oxide represented by Formula (II) at operation 110. Depending on, for example, an operating temperature, an operating time, and/or other parameters of the second conditions 162, the composition formed by operation 110 can include a sodium-containing manganese oxide having a P3-type structure 164 and/or a sodium-containing manganese oxide having a P2-type structure 166. Operation 110 is a referred to as a phase formation operation. The second conditions 162 of operation 110 can include an operating temperature and an operating time. The operating temperature of operation 110 can be about 550° C. or more and/or about 1,000° C. or less, such as from about 600° C. to about 950° C., such as from about 650° C. to about 900° C., such as from about 700° C. to about 850° C., such as from about 750° C. to about 800° C. In some examples, the operating temperature (° C.) of operation 110 can be 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1,000, or ranges thereof, though higher or lower temperatures are contemplated. Each of the foregoing numbers can be preceded by the word “about,” “at least about,” “less than about,” or “more than about,” and any of the foregoing numbers can be used singly to describe an open-ended range or in combination to describe a close-ended range. The operating time for operation 110 can be about 15 h or more, such as about 20 h or more, such as from about 20 h to about 72 h, such as from about 25 h to about 60 h, such as from about 30 h to about 48 h, such as from about 35 h to about 40 h, though greater or lesser operating times are contemplated. The second conditions 162 can include pulverizing or grinding the mixture 160 prior to, during, and/or after operation 110. Pulverizing or grinding can be performed by, for example, a mortar and pestle, though other suitable equipment can be utilized.

The second conditions 162 of operation 110 can include stirring, mixing, and/or agitating the mixture to ensure, for example, homogeneity of the mixture. Operation 110 can be performed in the presence of air or in an oxidizing atmosphere. Additionally, or alternatively, operation 110 can be performed using a non-reactive gas (such as N₂ and/or Ar). The second conditions 162 of operation 110 can include suitable operating pressures such as from 0.75 atm (75 kPa) to 1.5 atm (150 kPa), such as from 0.9 (90 kPa) to 1.1 atm (110 kPa), such as 1 atm (101 kPa), though other operating pressures are contemplated. Each of the foregoing numbers can be preceded by the word “about,” “at least about,” “less than about,” or “more than about,” and any of the foregoing numbers can be used singly to describe an open-ended range or in combination to describe a close-ended range. After a suitable time, operation 110 can be stopped and the product cooled.

As described above, selection of a desired operating temperature, operating time, and/or other parameters of the second conditions 162 in operation 110 can be used to form a composition comprising sodium-containing manganese oxide having a P3-type structure 164 and/or a sodium-containing manganese oxide having a P2-type structure 166. In some aspects, a sodium-containing manganese oxide having a P3-type structure 164 can be formed at an operating temperature of about 550° C. to about 750° C., such as any of those temperatures described above for the second conditions 162 for about 15 h to about 72 h, such as any of those operating times described above for the second conditions 162.

In some aspects, a sodium-containing manganese oxide having a P2-type structure 166 can be formed at an operating temperature of about 750° C. to about 1,000° C., such as any of those temperatures described above for the second conditions 162 for about 15 h to about 72 h, such as any of those operating times described above for the second conditions 162.

Although operation 105 and operation 110 are shown as separate operations, operations 105, 110, can be combined into a single operation. By performing operation 105 and 110, the sodium-containing manganese oxide represented by Formula (II) is formed.

The composition formed from operation 110 can include the P3-type structure 164 and/or the P2-type structure 166 of the sodium-containing manganese oxide. When the operating temperature of operation 110 is about 750° C. or less (such as those temperatures described above, e.g., about 600° C. to about 700° C.), the sodium-containing manganese oxide represented by Formula (II) that is present in the composition is characterized as being more than 50% P3-type structure, as being substantially P3-type structure, as consisting essentially of the P3-type structure, or consisting of the P3-type structure. When the operating temperature of operation 110 is about 750° C. or more (such as those temperatures described above, e.g., about 800° C. to about 900° C.), the sodium-containing manganese oxide represented by Formula (II) that is present in the composition is characterized as being more than 50% P2-type, as being substantially P2-type structure, as consisting essentially of the P2-type structure, or consisting of the P2-type structure.

The amount of P3-type structure and P2-type structure is determined by a linear fit of the PXRD data. For example, for very pure phases the ratio is close to 1:0 (100% P3-type structure) or 0:1 (100% P2-type structure). When a mixture of P3-type structure and P2-type structure is present, the ratio of P3-type structure to P2-type structure (or ratio of P2-type structure to P3-type structure) is determined using a linear combination of the diffraction patterns of the two phases as follows: Let A(2θ) be the diffraction pattern of the pure P3-type structure; B(2θ) be the diffraction pattern of the pure P2-type structure; and C(2θ) be the diffraction pattern of the combined phase. Assume C(2θ) can be fit by a function C′(2θ)=x0*A(2θ)+x1*B(2θ). A fitting algorithm is then used to find the parameters x0 and x1. These parameters are then used to calculate the structure ratio.

FIG. 1B is a flowchart showing selected operations of a process 120 to form a lithium-containing manganese oxide represented by Formula (I). The process 120 includes forming a composition comprising a sodium-containing manganese oxide represented by Formula (II) via operations 105 and 110. This composition can include a sodium-containing manganese oxide represented by Formula (II) having a P3-type structure 164 and/or a sodium-containing manganese oxide represented by Formula (II) having a P2-type structure 166, in any suitable ratio.

The process 120 further includes performing an ion exchange reaction to form a lithium-containing manganese oxide represented by Formula (I) at operation 115. Operation 115 includes introducing the sodium-containing manganese oxide represented by Formula (II) (the P3-type structure 164 or the P2-type structure 166) to a fourth precursor 167 under conditions effective (168, 170) to form the lithium-containing manganese oxide represented by Formula (I) (a O3/T3-type structure 172 or a O2/T2-type structure 174, depending on the starting phase of the sodium-containing manganese oxide). As further described below, the ion exchange reaction of operation 115 can be performed by various suitable methods such as by a solid-state method and a solvent method. Numeral 168 refers to ion exchange reaction conditions for the solid-state ion exchange method and numeral 170 refers to ion exchange reaction conditions for the ion exchange method using a solvent.

The fourth precursor 167 is a lithium-containing precursor such as a compound having lithium and a counterion, where the counterion is, for example, PF₆, NO₃⁻, CH₃CO₂⁻, OH⁻, O₂⁻, CO₃²⁻, I⁻, Br⁻, Cl⁻, F⁻, HCO₂⁻, O₂C₅H₇⁻, H⁻, SCN⁻, NO₂⁻, N₃⁻, C₂O₄²⁻, CN⁻, OCN⁻, CNO⁻, NH₂⁻, NH²⁻, NC⁻, NCS⁻, N(CN)₂⁻, or combinations thereof. Hydrates of the fourth precursor 167 are also contemplated. Illustrative, but non-limiting, examples of the fourth precursor 167 useful for operation 115 include lithium hexafluorophosphate (LiPF₆), lithium nitrate (LiNO₃), lithium bromide (LiBr), lithium chloride (LiCl), lithium iodide (LiI), lithium hydroxide (LiOH), hydrates thereof, or combinations thereof, such as LiPF₆, LiBr, LiCl, LiNO₃, or combinations thereof. Other lithium-containing precursors are contemplated.

The solid-state ion exchange conditions 168 for the solid-state ion exchange of operation 115 can include an operating temperature and an operating time. The operating temperature for the solid-state ion exchange conditions 168 can be about 200° C. or more and/or about 450° C. or less, such as from about 250° C. to about 400° C., such as from about 300° C. to about 350° C. In some examples, the operating temperature (° C.) of the solid-state ion exchange conditions 168 can be 200, 210, 220, 230, 240, 250, 260, 270, 280, 290, 300, 310, 320, 330, 340, 350, 360, 370, 380, 390, 400, 410, 420, 430, 440, or 450, or ranges thereof, though higher or lower temperatures are contemplated. Each of the foregoing numbers can be preceded by the word “about,” “at least about,” “less than about,” or “more than about,” and any of the foregoing numbers can be used singly to describe an open-ended range or in combination to describe a close-ended range. The operating time for the solid-state ion exchange conditions 168 can be about 15 h or more, such as about 20 h or more, such as from about 20 h to about 72 h, such as from about 25 h to about 60 h, such as from about 30 h to about 48 h, such as from about 35 h to about 40 h, though greater or lesser operating times are contemplated. The solid-state ion exchange conditions 168 can include pulverizing or grinding the materials used for operation 115 prior to, during, and/or after the solid-state ion exchange reaction. Pulverizing or grinding can be performed by, for example, a mortar and pestle, though other suitable equipment can be utilized.

For the solid-state ion exchange conditions 168, and in some aspects, a molar ratio of sodium-containing manganese oxide of Formula (II) (the P3-type structure 164 and/or the P2-type structure 166) to the fourth precursor 167 (a lithium-containing precursor) can be from about 1:2 to about 1:10, such as from about 1:2 to about 1:5, from about 1:5 to about 1:8, or about 1:10. In some examples, a molar ratio of sodium-containing manganese oxide of Formula (II) (the P3-type structure 164 and/or the P2-type structure 166) to the fourth precursor 167 (a lithium-containing precursor) can be 1:2, 1:3, 1:4, 1:5, 1:6, 1:7, 1:8, 1:9, or 1:10, though other ratios are contemplated. Each of the foregoing numbers can be preceded by the word “about,” “at least about,” “less than about,” or “more than about,” and any of the foregoing numbers can be used singly to describe an open-ended range or in combination to describe a close-ended range. The molar ratio of sodium-containing manganese oxide of Formula (II) (the P3-type structure 164 and/or the P2-type structure 166) to fourth precursor 167 for the solid-state ion exchange conditions 168 is based on the starting material molar ratio used for the reaction.

The solid-state ion exchange conditions 168 of operation 115 can include stirring, mixing, and/or agitating the mixture to ensure, for example, homogeneity of the mixture. The solid-state ion exchange reaction of operation 115 can be performed in the presence of air or in an oxidizing atmosphere. Additionally, or alternatively, the solid-state ion exchange reaction of operation 115 can be performed using a non-reactive gas (such as N₂ and/or Ar). The solid-state ion exchange conditions 168 of operation 115 can include suitable operating pressures such as from 0.75 atm (75 kPa) to 1.5 atm (150 kPa), such as from 0.9 (90 kPa) to 1.1 atm (110 kPa), such as 1 atm (101 kPa), though other operating pressures are contemplated. Each of the foregoing numbers can be preceded by the word “about,” “at least about,” “less than about,” or “more than about,” and any of the foregoing numbers can be used singly to describe an open-ended range or in combination to describe a close-ended range. After a suitable time, the solid-state ion exchange reaction can be stopped and the product cooled.

An illustrative, but non-limiting, example of a solid-state ion exchange operation can include mixing sodium-containing manganese oxide of Formula (II) (P3-type or P2-type) with LiBr and pulverizing the mixture. The mixture is then transferred to a crucible for heating at a target temperature (about 200° C.) for about 20 h.

As described above, the ion exchange reaction of operation 115 can be performed using a solvent under solvent ion exchange conditions 170. Solvents that can be used for the ion exchange reaction include, but are not limited to, acetonitrile, N-methyl-2-pyrrolidone (NMP), N,N-dimethylformamide (DMF), dimethyl sulfoxide (DMSO), tetrahydrofuran (THF), acetone, an alcohol solvent (ethanol, methanol, butanol, hexanol, propanol), an aromatic solvent (e.g., toluene), ethylene carbonate, diethylene carbonate, and combinations thereof, such as acetonitrile, hexanol, toluene, ethylene carbonate, diethylene carbonate, or combinations thereof. In some examples, a mixture of solvents can be used where the wt/wt % ratio of the mixture of solvents can be from about 1:9 to about 9:1, such as from about 2:8 to about 8:2, such as from about 3:7 to about 7:3, such as from about 4:6 to about 6:4, such as about 5:5, though other values are contemplated. Each of the foregoing numbers can be preceded by the word “about,” “at least about,” “less than about,” or “more than about,” and any of the foregoing numbers can be used singly to describe an open-ended range or in combination to describe a close-ended range.

Solvent ion exchange conditions 170 of operation 115 can include an operating temperature and an operating time. The operating temperature for the solvent ion exchange conditions 170 can be about 15° C. or more and/or about 200° C. or less, such as from about 15° C. to about 200° C., such as from about 25° C. to about 150° C., such as from about 50° C. to about 125° C., such as from about 75° C. to about 100° C. In some examples, the operating temperature (° C.) of the solvent ion exchange conditions 170 can be 15, 25, 30, 40, 50, 60, 70, 80, 90, 100, 110, 120, 130, 140, 150, 160, 170, 180, 190, or 200, or ranges thereof, though higher or lower temperatures are contemplated. Each of the foregoing numbers can be preceded by the word “about,” “at least about,” “less than about,” or “more than about,” and any of the foregoing numbers can be used singly to describe an open-ended range or in combination to describe a close-ended range. The operating time for the solvent ion exchange conditions 170 can be about 1 h or more, such as about 2 h or more, such as from about 2 h to about 40 h, such as from about 5 h to about 20 h, such as from about 10 h to about 15 h, though greater or lesser operating times are contemplated. The solvent ion exchange conditions 170 can include pulverizing or grinding the starting materials prior to, during, and/or after the solvent ion exchange reaction. Pulverizing or grinding can be performed by, for example, a mortar and pestle, though other suitable equipment can be utilized. The solvent ion exchange conditions 170 can include stirring, mixing, and/or agitating the starting materials and the solvent during the ion exchange reaction to ensure, for example, homogeneity of the mixture.

For the solvent ion exchange conditions 170, and in some aspects, a molar ratio of sodium-containing manganese oxide of Formula (II) (the P3-type structure 164 and/or the P2-type structure 166) to the fourth precursor 167 (a lithium-containing precursor) can be from about 1:2 to about 1:10, such as from about 1:2 to about 1:5, from about 1:5 to about 1:8, or about 1:10. In some examples, a molar ratio of sodium-containing manganese oxide of Formula (II) (the P3-type structure 164 and/or the P2-type structure 166) to the fourth precursor 167 (a lithium-containing precursor) can be 1:2, 1:3, 1:4, 1:5, 1:6, 1:7, 1:8, 1:9, or 1:10, though other ratios are contemplated. Each of the foregoing numbers can be preceded by the word “about,” “at least about,” “less than about,” or “more than about,” and any of the foregoing numbers can be used singly to describe an open-ended range or in combination to describe a close-ended range. The molar ratio of sodium-containing manganese oxide of Formula (II) (the P3-type structure 164 or the P2-type structure 166) to fourth precursor 167 for the solvent ion exchange conditions 170 is based on the starting material molar ratio used for the reaction.

The solvent ion exchange conditions 170 of operation 115 can include stirring, mixing, and/or agitating the mixture to ensure, for example, homogeneity of the mixture. The solvent ion exchange reaction of operation 115 can be performed in the presence of air or in an oxidizing atmosphere. Additionally, or alternatively, the solvent ion exchange reaction of operation 115 can be performed using a non-reactive gas (such as N₂ and/or Ar). The solvent ion exchange conditions 170 of operation 115 can include suitable operating pressures such as from 0.75 atm (75 kPa) to 1.5 atm (150 kPa), such as from 0.9 (90 kPa) to 1.1 atm (110 kPa), such as 1 atm (101 kPa), though other operating pressures are contemplated. Each of the foregoing numbers can be preceded by the word “about,” “at least about,” “less than about,” or “more than about,” and any of the foregoing numbers can be used singly to describe an open-ended range or in combination to describe a close-ended range. After a suitable time, the solvent ion exchange reaction can be stopped and the reaction mixture cooled if desired. The reaction mixture can be centrifuged to collect the ion-exchanged product as a lithium-containing manganese oxide of Formula (I) (03/T3-type or O2/T2-type).

An illustrative, but non-limiting, example of a solvent ion exchange operation can include mixing sodium-containing manganese oxide of Formula (II) (P3-type or P2-type) with LiBr and pulverizing the mixture. Hexanol can then be added to the mixture and the resultant mixture can be stirred for about 2 hours at a temperature of about 80° C. to about 130° C. Another illustrative, but non-limiting, example of a solvent ion exchange operation can include mixing sodium-containing manganese oxide of Formula (II) (P3-type or P2-type) with a lithium source (LiPF₆ in ethylene carbonate (EC) and diethylene carbonate (DEC)). The resultant mixture can be stirred for about 2 hours at a temperature of about 15° C. to about 25° C.

The ion exchange, by either method (or combinations of the two methods), can be performed once or more than once, such as once, twice, three times, or more. For example, the same amount of fourth precursor 167 (the lithium-containing precursor), same temperature, and/or same time, among other parameters, can be utilized for each of the one or more ion exchanges. Alternatively, different fourth precursor 167, different temperature, and/or different times, among other parameters, can be utilized for each of the one or more ion exchanges.

After either the solid-state or solvent-based ion exchange reaction of operation 115, the resultant mixture (comprising the lithium-containing magnesium oxide of Formula (I) (the O3/T3-type structure 172 or the O2/T2-type structure 174) can be optionally washed to remove undesired components and isolate the desired lithium-containing manganese oxide. Suitable solvents for washing include polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the lithium-containing magnesium oxide of Formula (I) from other components in the ion exchange reaction mixture. The lithium-containing magnesium oxide of Formula (I) can then be optionally dried under vacuum and/or at elevated temperature to remove excess solvent from the washing operation.

Before, during, or after any of operation 105, operation 110, and/or operation 115, the starting materials or products can be subjected to filtration, separation, cleaning, quenching, washing, purification, and/or other suitable processes to remove undesired components and isolate the desired components. Starting materials and products can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating desired components from the undesired components. Collection of the desired materials can further include centrifuging and collecting the desired material. Drying can be performed at elevated temperatures and/or under vacuum to remove residual liquids.

### Example Energy Storage Device

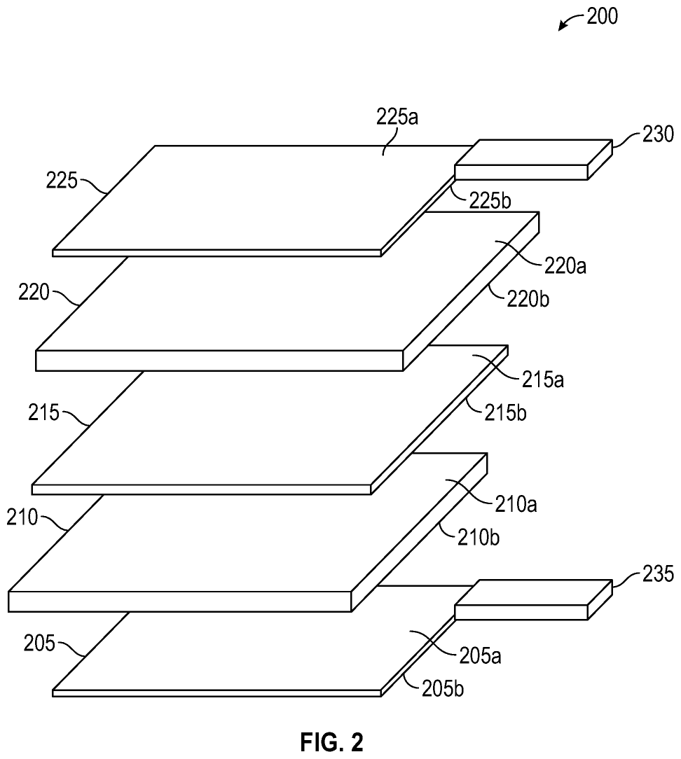

Aspects described herein also generally relate to energy storage devices such as batteries. FIG. 2 is an exploded perspective view of a battery 200 according to at least one aspect of the present disclosure. The embodiment of the battery 200 shown in FIG. 2 is for illustrative purposes only and is non-limiting. The battery 200 can be a lithium battery or a sodium battery. In some aspects, the battery 200 can be a secondary battery or a rechargeable battery. The battery 200 can have any suitable configuration such as a half-cell type, a coin type, a button type, a cylindrical type, flat-plate type, an all solid type, or a spirally wound type, though other configurations are contemplated. Relative to conventional batteries incorporating such conventional manganese oxides, the manganese oxides of the present disclosure can increase battery capacity, increase the voltage of the battery, improve battery cycle life, among other electrochemical performance properties.

The battery 200 includes a first current collector 205, having a top surface 205a and a bottom surface 205b. The battery 200 further includes a cathode 210 disposed on or over at least a portion of the first current collector 205. As shown in FIG. 2, a bottom surface 210b of the cathode 210 is disposed on or over at least a portion of the top surface 205a of the first current collector 205. The first current collector 205 can serve to collect electrons from the cathode 210 and to supply electrons to the cathode 210 during charge-discharge processes of the battery 200.

The cathode 210 can include at least one cathode active material (for example, at least one lithium-containing manganese oxide of Formula (I), at least one sodium-containing manganese oxide of Formula (II), or combinations thereof). The cathode 210 can further include one or more additional components such as a conductive agent and a binder. Example cathodes and cathode compositions are described above.

A separator 215 is disposed on or over at least a portion of the cathode 210, such that a bottom surface 215b of the separator is disposed on or over at least a portion of the top surface 210a of the cathode 210. Various separators can be used with aspects described herein. The separator 215 can be single ply or multi-ply. The separator 215 can include at least one layer composed of or including one or more polymers. Suitable materials useful for the separator 215 include those known to persons of ordinary skill in the art for use in between battery anodes and cathodes, to provide a barrier between the anode and the cathode while enabling the exchange of lithium ions from one side to the other, such as a membranous barrier or a separator membrane. The separator membrane can be permeable to lithium ions, allowing them to travel from the cathode side to the anode side and back during the charge-discharge cycle. The separator membrane can be impermeable to anode and cathode materials, preventing them from mixing, touching, and shorting the battery. The separator membrane can also serve as an electrical insulator for metal parts of the battery (leads, tabs, metal parts of the enclosure, et cetera) preventing them from touching and shorting. Illustrative, but non-limiting, examples of suitable materials that can be used the one or more polymers of the separator 215 include polyolefins such as polypropylene, polyethylene, polyimidazoles, polybenzimidazole (PBI), polyimides, polyamideimides, polyaramids, polysulfones, polyvinylidene fluoride, aromatic polyesters, polyketones, polytetrafluoroethylene (PTFE), blends thereof, mixtures thereof, and combinations thereof. Commercial polymer separators include, for example, the Celgard™ line of separators.

In some aspects, the separator 215 is a thin (about 15-25 μm) polymer membrane (tri-layer composite: polypropylene-polyethylene-polypropylene, commercially available) between two relatively thick (about 20-1000 μm) porous electrode sheets. The thin polymer membrane may be about 15-25 μm thick, such as 15-23, 15-21, 15-20, 15-18, 15-16, 16-25, 16-23, 16-21, 16-20, 16-18, 18-25, 18-23, 18-21, 18-20, 20-25, 20-23, 20-21, 21-25, 21-23, 23-25, 15, 16, 17, 18, 19, 20, 21, 22, 23, 24, or 25 μm thick, or any integer or subrange in between. The two relatively thick porous electrode sheets may each independently be 50-500 μm thick, such as 50-450 μm, 50-400 μm, 50-350 μm, 50-300 μm, 50-250 μm, 50-200 μm, 50-150 μm, 50-100 μm, 50-75 μm, 50-60 μm, 50-55 μm, 55-500 μm, 55-450 μm, 55-400 μm, 55-350 μm, 55-300 μm, 55-250 μm, 55-200 μm, 55-150 μm, 55-100 μm, 55-75 μm, 55-60 μm, 60-500 μm, 60-450 μm, 60-400 μm, 60-350 μm, 60-300 μm, 60-250 μm, 60-200 μm, 60-150 μm, 60-100 μm, 60-75 μm, 75-500 μm, 75-450 μm, 75-400 μm, 75-350 μm, 75-300 μm, 75-250 μm, 75-200 μm, 75-150 μm, 75-100 μm, 100-500 μm, 100-450 μm, 100-400 μm, 100-350 μm, 100-300 μm, 100-250 μm, 100-200 μm, 100-150 μm, 150-500 μm, 150-450 μm, 150-400 μm, 150-350 μm, 150-300 μm, 150-250 μm, 150-200 μm, 200-500 μm, 200-450 μm, 200-400 μm, 200-350 μm, 200-300 μm, 200-250 μm, 250-500 μm, 250-450 μm, 250-400 μm, 250-350 μm, 250-300 μm, 300-500 μm, 300-450 μm, 300-400 μm, 300-350 μm, 350-500 μm, 350-450 μm, 350-400 μm, 400-500 μm, 400-450 μm, 450-500 μm, 50 μm, 55 μm, 60 μm, 75 μm, 100 μm, 150 μm, 200 μm, 250 μm, 300 μm, 350 μm, 400 μm, 450 μm, or 500 μm, or any integer or subrange in between. Other dimensions and materials for the separator 215 are contemplated.

The battery 200 further includes an anode 220 having a bottom surface 220b, the bottom surface 220b of the anode 220 being disposed on or over at least a portion of a top surface 215a of the separator 215. The anode 220 can include a composite material that includes lithium metal in the form of, for example, particles. The composite material of the anode 220 can include an anode active material (such as graphite, silicon, a porous material that matches or substantially matches the potential of the given cathode material, natural graphite, artificial graphite, activated carbon, carbon black, high-performance powdered graphene, etcetera, and combinations thereof). The composite material of the anode 220 can further include carbon nanotubes in the form of a three-dimensional cross-linked network. In some aspects, the anode active material of the anode 220 can include Si, SiOx/C, graphite, or combinations thereof. Other materials for the anode 220 and the anode active material are contemplated.

The battery 200 further includes a second current collector 225 having a top surface 225a and a bottom surface 225b. The bottom surface 225b of the second current collector 225 is disposed on or over at least a portion of a top surface 220a of the anode 220. The second current collector 225 can serve to collect electrons from the anode 220 and to supply electrons to the anode 220 during charge-discharge processes in the battery 200.

The first current collector 205 and the second current collector 225 include an electrically conductive material (for example, electrically conductive metal, electrically conductive metal alloy, other electrically conductive material, or combinations thereof) can include copper, aluminum, nickel, platinum, zinc, titanium, stainless steel, sintered carbon, or combinations thereof. In some aspects, the first current collector 205—which is the current collector for the cathode 210—comprises aluminum as an electrically conductive material; the second current collector 225—which is the current collector for the anode 220—comprises copper as an electrically conductive material; and combinations thereof. A thickness of the current collector (for example, the first current collector 205 and/or the second current collector 225) can be about 1,000 μm or less, such as about 500 μm or less, such as about 400 μm or less, such as about 300 μm or less, such as about 200 μm or less, such as about 100 μm or less. A higher or lower thickness of the first current collector 205 and the second current collector 225 is contemplated. The thickness of the current collector can be adjusted based on the resistance to current or mechanical strength desired.

Optionally, the battery 200 can further include a first tab 230 (also known as a lead) contacting an exposed surface of the second current collector 225 and a second tab 235 (also known as a lead) contacting an exposed surface of the first current collector 205. The first tab 230 can be soldered or fused to the first current collector 205, and the second tab 235 can be soldered or fused to the second current collector 225. Soldering or fusing of the first tab 230 to the first current collector 205 can be performed via a low-resistance contact formed between the first tab 230 and conductive component(s) of the first current collector 205. Soldering or fusing of the second tab 235 to the second current collector 225 can be performed in the same manner. Although not shown, the battery 200 can include one or more electrolytes.

Any suitable electrolyte can be used with aspects described herein. In some aspects, the electrolyte can include a liquid electrolyte, a solid electrolyte, a gel electrolyte, a polymer ionic liquid. In at least one aspect, the gel electrolyte can be any suitable gel electrolyte known in the art. For example, the gel electrolyte can include a polymer and a polymer ionic liquid. For example, the polymer can be a solid graft (block) copolymer electrolyte. In some aspects, the solid electrolyte can be, for example, an organic solid electrolyte or an inorganic solid electrolyte. Non-limiting examples of the organic solid electrolyte can include polyethylene derivatives, polyethylene oxide derivatives, polypropylene oxide derivatives, phosphoric acid ester polymer, polyester sulfide, polyvinyl alcohol, polyfluoride vinylidene, and polymers including ionic dissociative groups. A combination comprising at least one of the foregoing can also be used.

When a liquid electrolyte is utilized, the liquid electrolyte can be a non-aqueous liquid electrolyte, aqueous liquid electrolyte, or a combination thereof. The non-aqueous liquid electrolyte can include an electrolyte salt and a non-aqueous solvent. Illustrative, but non-limiting, examples include propylene carbonate, ethylene carbonate, vinylene carbonate, dimethyl carbonate, ethyl methyl carbonate, diethyl carbonate, methyl propyl carbonate, isopropyl methyl carbonate, ethyl propionate, methyl propionate, γ-butyrolactone, ethyl acetate, methyl acetate, tetrahydrofuran, 2-methyltetrahydrofuran, ethylene glycol dimethyl ether, ethylene glycol diethyl ether, acetonitrile, dimethyl sulfoxide, diethoxyethane, 1,1-dimethoxyethane, tetraethylene glycol dimethyl ether, and combinations thereof.

An ionic liquid can be used as the non-aqueous solvent. Examples of ionic liquids can include aliphatic quaternary ammonium salts such as N,N,N-trimethyl-N-propylammonium bis(trifluoromethanesulfonyl)amide, N-methyl-N-propylpiperidinium bis(trifluoromethanesulfonyl)amide, N-methyl-N-propylpyrrolidinium bis(trifluoromethanesulfonyl)amide, N-methyl-N-butylpyrrolidinium bis(trifluoromethanesulfonyl)amide, and N,N-diethyl-N-methyl-N-(2-methoxyethyl)ammonium bis(trifluoromethanesulfonyl)amide; and alkylimidazolium quaternary salts such as 1-methyl-3-ethylimidazolium tetrafluoroborate, 1-methyl-3-ethylimidazolium bis(trifluoromethanesulfonyl)amide, 1-allyl-3-ethylimidazolium bromide, 1-allyl-3-ethylimidazolium tetrafluoroborate, 1-allyl-3-ethylimidazolium bis(trifluoromethanesulfonyl)amide, 1,3-diallylimidazolium bromide, 1,3-diallylimidazolium tetrafluoroborate, 1,3-diallylimidazolium bis(trifluoromethanesulfonyl)amide, and combinations thereof.

The electrolyte salt can be soluble in non-aqueous solvents and able to exhibit desired ion conductivity. For example, a metal salt containing a metal ion desired to be conducted, can be used as the electrolyte salt. For example, lithium salts can be used as the electrolyte salt. For example, lithium salts such as LiPF₆, LiBF₄, LiClO₄, LiAsF₆, LiOH, LiCl, LiNO₃ and Li₂SO₄; and organic lithium salts such as CH₃CO₂Li, lithium bis(oxalate)borate (LiBOB), LiN(CF₃SO₂)₂ (LiTFSA), LiN(C₂F₅SO₂)₂ (LiBETA), and/or LiN(CF₃SO₂)(C₄F₉SO₂) can be utilized.

The content the electrolyte salt relative to the non-aqueous solvent in the non-aqueous liquid electrolyte can be appropriately determined depending on the combination of the solvent and the electrolyte salt. The non-aqueous liquid electrolyte may be used in the form of gel by adding a polymer thereto. Examples of methods for gelation of the non-aqueous liquid electrolyte, include a method of adding a polymer such as polyethylene oxide (PEO), polyacrylonitrile (PAN), polyvinylidene fluoride (PVDF) or polymethyl methacrylate (PMMA) to the non-aqueous liquid electrolyte.

Examples of the aqueous liquid electrolyte can include alkaline aqueous solutions such as potassium hydroxide aqueous solution and/or sodium hydroxide aqueous solution. Examples of the aqueous liquid electrolyte can include acidic aqueous solutions such as hydrochloric acid solution, nitric acid solution, and/or sulfuric acid solution. The aqueous liquid electrolyte can be appropriately selected, depending on, for example, the type of the anode active material.

Solid electrolyte can be utilized. Non-limiting examples of the solid electrolyte include inorganic solid electrolytes such as a solid sulfide electrolyte and/or a solid oxide electrolyte. The inorganic solid electrolyte can be in the form of glass, crystal, and/or glass ceramic. Solid sulfide electrolytes contain sulfur (S) and are ion-conductive. Non-limiting examples of solid sulfide electrolyte materials can include Li₂S—P₂S₅ (Li₂S:P₂S₅=50:50 to 100:0), Li₂S—P₂S₅—LiI, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (Z═Ge, Zn, Ga; m is the amount Z; and n is the amount of sulfur), Li₂S—GeS₂, Li₂S—SiS₂—Li₃PO₄, and/or Li₂S—SiS₂—LiₓMO_{y} (M=P, Si, Ge, B, Al, Ga, In; x is the amount Li; and y is the amount of oxygen). Solid oxide electrolytes include LiPON (lithium phosphorus oxynitride), LiAlTi type (for example, Li_{1.3}Al_{0.3}Ti_{0.7}(PO₄)₃), LaLiTi type (for example, La_{0.51}Li_{0.34}TiO_{0.74}), Li₃PO₄, Li₂SiO₂, and/or Li₂SiO₄. Other materials for the electrolyte are contemplated. Combinations of various electrolytes can be used.

Aspects described also generally relate to uses of the cathodes in batteries and such batteries can be utilized with, or otherwise incorporated into, various devices utilizing batteries such as automobiles, other land vehicles (trucks), trains, aircraft, watercraft, satellite systems. An exemplary, but non-limiting, battery is described in relation to FIG. 2.

In at least one aspect, the battery 200 can be electrically coupled by known methods to any suitable article, or one or more components of the article, that is or can be operated by an battery. Illustrative, but non-limiting, examples of such articles can include a land vehicle (e.g., a car, motorcycle, truck, bus, scooter, train, tram), a bicycle, an aircraft (e.g., an airplane, helicopter, aerostat), a watercraft (e.g., a ship, boat, underwater vehicle), an amphibious vehicle (e.g., screw-propelled vehicle, hovercraft), a spacecraft, a satellite, a light emitting diode, a consumer electronic (such as a laptop computer, an antenna, a car radio, a mobile phone, a watch, and a telecommunication base station), a motor, a wind turbine, a bridge, a building, a pipeline, a smart grid, or components thereof. The battery 200 can be incorporated into various other devices such as storage batteries for power generating units using wind power or sunlight, electric vehicles, uninterruptable power supplies (UPS), and household storage batteries. The battery 200 can also be used as a unit battery of a medium-large size battery pack or battery module that includes a plurality of battery cells for use as a power source of a medium-large size device. The aforementioned uses are non-limiting and other uses are contemplated.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (such as the amounts, dimensions) but some experimental errors and deviations should be accounted for.

### Examples

### Materials and Methods

Sodium nitrate (NaNO₃, anhydrous) was purchased from Acros Organics. Manganese(II) carbonate (MnCO₃) and nickel(II) nitrate hexahydrate (Ni(NO₃)₂·6H₂O) were purchased from Sigma-Aldrich. Lithium bromide (LiBr) was purchased from Acros Organics. LP47 electrolyte (1 M LiPF₆ in EC/DEC=3/7 by weight) was purchased from Gotion, Inc. The LP47 electrolyte is a 1 M LiPF₆ salt dissolved in a 3:7 (by weight (wt/wt)) mixture of ethylene carbonate (EC) and diethylene carbonate (DEC). All chemicals were used as received.

### Characterization

Powder x-ray diffraction (PXRD) patterns were obtained using a Bruker D8 Advance x-ray diffractometer with Cu Kα1 (1.54056 Å) radiation operated at a tube voltage of 40 kV and a current of 40 mA. The PXRD patterns were collected at room temperature in a continuous scan mode with a step size of 0.01 deg with 0.5 s duration for each step ranging from 2θ=10° to 80°. Samples for PXRD were prepared as follows. The final product after solid-state reaction or after drying (in solvent method) was ground manually in a mortar and pestle before further characterization. A portion of the sample was packed for PXRD measurement.

Galvanostatic charge and discharge data was collected at room temperature using a BioLogic BCS-810 testing module using a current density of 10 mA/g and a voltage cutoff of 4.7 V and 2.0 V for charge and discharge, respectively. Samples for the galvanostatic charge and discharge data were prepared as follows. A uniform slurry of cathode active material (8 parts), acetylene black (1 part), polyvinylidene fluoride (PVDF) (1 part), with a weight ratio of about 8:1:1, in N-methyl-2-pyrrolidone (NMP) solvent was prepared using a Thinky-320 mixer. The resulting slurry was cast on aluminum foil using a doctor-blade with 6 mil thickness in wet form to form a coating. The coating was dried at about 120° C. under vacuum for about 10 hours to remove the NMP solvent. The dried electrode sheet was then cut into circles (10 mm diameter) and pressed at 2 MPa for 2 min before using as the cathode electrode. CR2032 coin cells were then assembled using the cathode electrode, which was against a 200 μm thickness of lithium foil and a Celgard separator in an argon-filled glovebox. Here, the layers in the coin cell are cathode electrode, separator with electrolyte, and Li metal foil (the Li metal foil having a thickness of about 200 μm). A 10 μL sulfonamide based electrolyte (Lithium bis(fluorosulfonyl) imide (LiFSI) salt dissolved in N,N-dimethyltrifluoromethanesulfonamide (DMCF₃SA) solvent) was used along with one layer of Celgard separator in each coin cell. To prevent corrosion of the coin cell case due to contact with the electrolyte, an additional layer of aluminum foil (diameter of 19 mm) was used on top of the cathode. The half cells were initially cycled at 10 mA/g current density with a voltage window of 4.7-2.0 V on the BioLogic BCS-810 testing module.

The metal content of the sodium-containing manganese oxides and lithium containing manganese oxides were determined by inductively coupled plasma optical emission spectroscopy (ICP-OES). ICP-OES was conducted using a Perkin Elmer Avio 500 instrument with software of Syngistix for ICP Version 5.1.0.0293. During the measurement, the RF power is 1300 W with Ar flow, Auxillary Ar flow and Nebulizer gas flow of 15.0 L/min, 0.2 L/min and 0.8 L/min respectively. The signal of each element was measured at the following wavelength in nm: Li 670.784, Li 610.362, Na 589.592, Na 588.995, Mn 257.610, Mn 260.568, Mn 294.92, Ni 232.003, Ni 227.022, Al 309.271, Al 394.401 and Cu 324.752 Cu 327.393. All elements analyzed were calibrated with a minimum calibration coefficient of 0.999. The content of each element was calculated based on the averaged content at all the corresponding wavelength. ICP-OES is performed as follows: 0.5 mg of the lithium-containing manganese oxide is dissolved in 10 mL concentrated HNO₃ with 10 drops of H₂O₂. The resulting mixture was diluted with deionized water to 100 mL after the solid (lithium-containing manganese oxide) is fully dissolved. The resulting solution is filtered with a micro-filter and tested with ICP-OES to determine the concentration of metal ions, including Li⁺, Na⁺, Ni²⁺, Cu²⁺, Al³⁺, among others. The amount of oxygen component was assumed to be stoichiometric of 2.0 since the oxygen close packing is standard in these oxide materials and ICP-OES does not measure it directly.

Average particle diameter was determined by a scanning electron microscope (SEM, QUANTA FEG 650) with an accelerating voltage of 5 kV.

### Example Synthesis of an P3-Type and P2-Type Sodium-Containing Manganese Oxides

P3-type and P2-type sodium-containing manganese oxide (Na_{2/3}Ni_{1/3}Mn_{2/3}O₂) was synthesized using a solid state reaction. Stoichiometric precursors of NaNO₃ (˜0.028 mol, ˜2.3797 g), MnCO₃ (˜0.028 mol, ˜3.2186 g), and Ni(NO₃)₂·6H₂O (˜0.014 mol, ˜4.0698 g) were mixed using a mortar and pestle, with grinding, for about 10 minutes (min). For the initial decomposition, the mixture was transferred to a crucible and heated at about 500° C. for about 12 hours (h) to form a pre-heated product. Phase formation to form the P3-phase of Na_{2/3}Ni_{1/3}Mn_{2/3}O₂ was then accomplished by grinding the pre-heated product with a mortar and pestle again and heated at about 600° C. for about 24 h. The P2-phase of Na_{2/3}Ni_{1/3}Mn_{2/3}O₂ was obtained by grinding the pre-heated product with a mortar and pestle again followed by heating at about 900° C. for about 20 h.

Different precursors containing different metals, and under similar conditions, can be used to make P3-type and P2-type sodium-containing manganese oxides of Formula (II) where, for example, M² is Cu or LiAl. For example, Cu(NO₃)₂·3H₂O was used as a copper source to make P3-type and P2-type sodium-containing manganese oxides having the formula Na_{2/3}Cu_{1/3}Mn_{2/3}O₂. LiOH and Al (OH)₃ were used as a lithium-aluminum (LiAl) source to make P3-type and P2-type sodium-containing manganese oxides having the formula Na_{2/3}(Li_{1/6}Al_{1/6})Mn_{2/3}O₂. Other P3-type and P2-type sodium-containing manganese oxides of Formula (II) where M² is a different metal can be obtained by similar procedures.

Example Synthesis of an O3/T3-type and O2/T2-type Lithium-containing Manganese Oxides

An ion-exchange reaction was then performed using two different methods, depending on, for example, the desired reaction temperature.

At room temperature (about 15° C. to about 25° C.), a solvent ion exchange method was performed using a commercial LP47 electrolyte (˜1 M LiPF₆ in EC/DEC=3/7 by weight) as a Li⁺ source. For a typical solvent ion exchange reaction, a mixture of about 1.5 g of the P2-type or the P3-type Na-phase (Na_{2/3}Ni_{1/3}Mn_{2/3}O₂) and a Li salt (LP47 electrolyte in this case; about 100 mL) was made. The molar ratio of the Na-phase to Li salt (LiPF₆ in this case) was about 1:7. The mixture was stirred for about 4 h, then transferred to a centrifuge to collect a reaction mixture containing the ion-exchanged product. The excess Li salt was washed away from the reaction mixture using methanol to obtain a lithium-containing manganese oxide having the formula Li_{(2/3-n)}NaₙNi_{1/3}Mn_{2/3}O₂ (where n is less than or equal to about 0.02), for example Li_{0.67}Na_{0.02}Ni_{0.36}Mn_{0.73}O₂. The O2/T2-type or O3/T3-type structure of the lithium-containing manganese oxide is obtained based on the P2-type or P3-type Na-phase used for the ion exchange reaction.

At about 80° C., the solvent ion exchange method was also performed using a mixture of about 1.5 g of the P2-type or the P3-type Na-phase (Na_{2/3}Ni_{1/3}Mn_{2/3}O₂) and a Li salt (LiBr; from about 0.84 g to about 8.4 g). The molar ratio of the Na-phase to Li salt (LiBr in this case) was from about 1:1 to about 1:10. To the mixture of Na-phase and Li salt was added hexanol (20 mL) as solvent. The mixture was stirred for about 4 h, then transferred to a centrifuge to collect the ion-exchanged product. The excess Li salt was washed away from the reaction mixture using methanol to obtain a lithium-containing manganese oxide having the formula Li_{(2/3-n)}NaₙNi_{1/3}Mn_{2/3}O₂ (where n is less than or equal to about 0.03), for example Li_{0.72}Na_{0.03}Ni_{0.36}Mn_{0.69}O₂. The O2/T2-type or O3/T3-type structure of the lithium-containing manganese oxide is obtained based on the Na-phase used for the ion exchange reaction.

At about 130° C., the solvent ion exchange method was also performed using a mixture of about 1.5 g of the P2-type or the P3-type Na-phase (Na_{2/3}Ni_{1/3}Mn_{2/3}O₂) and a Li salt (LiBr; about 8.4 g). The molar ratio of the Na-phase to Li salt (LiBr in this case) was about 1:10. To the mixture of Na-phase and Li salt was added hexanol (20 mL) as solvent. The mixture was stirred for about 4 h, then transferred to a centrifuge to collect the ion-exchanged product. The excess Li salt was washed away from the reaction mixture using methanol to obtain a lithium-containing manganese oxide having the formula Li_{(2/3-n)}NaₙNi_{1/3}Mn_{2/3}O₂ (where n is less than or equal to about 0.02), for example Li_{0.78}Na_{0.02}Ni_{0.34}Mn_{0.68}O₂. The O2/T2-type or O3/T3-type structure of the lithium-containing manganese oxide is obtained based on the Na-phase used for the ion exchange reaction.

For the solid-state ion-exchange reaction, LiBr was used. A mixture of about 1.2 g of the P2-type or the P3-type Na-phase (Na_{2/3}M_{1/3}Mn_{2/3}O₂) and an Li salt (LiBr in this case; about 6.7 g), were hand mixed with a mortar and pestle quickly (about 1 minute) because LiBr is hygroscopic. The molar ratio of the Na-phase to Li salt was about 1:10. The resultant mixture was transferred to a crucible and heated at a targeted temperature (e.g., about 200° C., about 250° C., and about 330° C.) for at least about 20 h to obtain a lithium-containing manganese oxide after washing away the excess Li salt using methanol. The lithium-containing manganese oxide had the formula Li_{(2/3-n)}NaₙNi_{1/3}Mn_{2/3}O₂ (where n is less than or equal to about 0.03), for example Li_{0.79}Na_{0.04}Ni_{0.34}Mn_{0.69}O₂, Li_{0.8}Na_{0.03}Ni_{0.34}Mn_{0.69}O₂, and Li_{1.15}Na_{0.006}Ni_{0.30}Mn_{0.63}O₂ at about 200° C., about 250° C. and about 330° C. respectively. The O2/T2-type or O3/T3-type structure of the lithium-containing manganese oxide is obtained based on the Na-phase used for the ion exchange reaction.

The ion exchange, by either method, can be performed one or more times. For example, the same amount of Li source, same temperature, and same time can be utilized for each of the one or more times.

Additionally, O3/T3-type and O2/T2-type lithium-containing manganese oxides represented by Formula (I) can be made under similar conditions where, for example, M¹ is Cu²¹ or Li⁺Al³⁺. Here, the appropriate sodium-containing manganese oxide is converted to the targeted lithium-containing manganese oxide: Li_{(2/3-n)}NaₙCu_{1/3}Mn_{2/3}O₂, where n is less than or equal to about 0.05 or Li_{(2/3-n)}Naₙ(Li_{1/6}Al_{1/6})Mn_{2/3}O₂, where n is less than or equal to about 0.05. Other O3/T3-type and O2/T2-type lithium-containing manganese oxides of Formula (I) where M¹ is a different metal can be obtained by similar procedures.

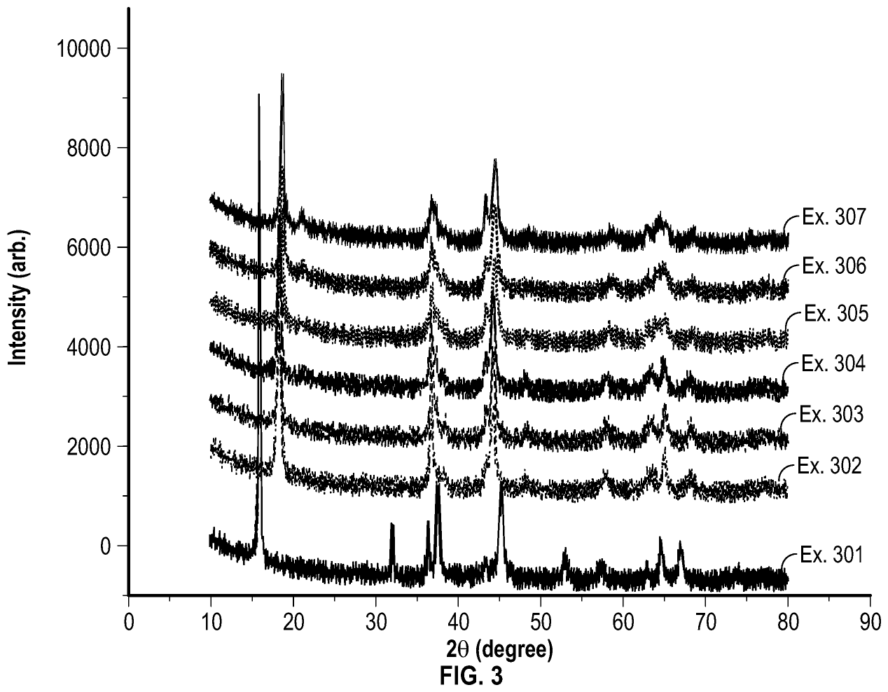

FIG. 3 shows exemplary PXRD patterns of example O3/T3-type lithium-containing manganese oxides formed from a P3-type sodium-containing manganese oxide (Na_{2/3}Ni_{1/3}Mn_{2/3}O₂; Ex. 301) at various temperatures. Examples 302, 303, and 304 were made using the solvent ion exchange method at a temperature of about room temperature, 80° C., and about 130° C., respectively. Examples 305, 306, and 307 were made using the solid-state ion exchange method at a temperature of about 200° C., about 250° C., and about 330° C., respectively. The O3/T3-type lithium-containing manganese oxides of Examples 302-307 have the formula Li_{(2/3-n)}NaₙNi_{1/3}Mn_{2/3}O₂, where n is less than or equal to about 0.05. Table 1 shows the formula of Examples 301-307. The results indicated that the ion exchange reaction can be performed successfully at different temperatures using various ion exchange methods.

TABLE 1

| Ex. # | Formula |
|---|---|
| 301 | Na_{0.64}Ni_{0.32}Mn_{0.63}O₂ |
| 302 | Li_{0.67}Na_{0.02}Ni_{0.36}Mn_{0.73}O₂ |
| 303 | Li_{0.71}Na_{0.03}Ni_{0.36}Mn_{0.69}O₂ |
| 304 | Li_{0.78}Na_{0.02}Ni_{0.34}Mn_{0.68}O₂ |
| 305 | Li_{0.79}Na_{0.04}Ni_{0.34}Mn_{0.69}O₂ |
| 306 | Li_{0.80}Na_{0.03}Ni_{0.34}Mn_{0.69}O₂ |
| 307 | Li_{1.15}Na_{0.006}Ni_{0.30}Mn_{0.73}O₂ |

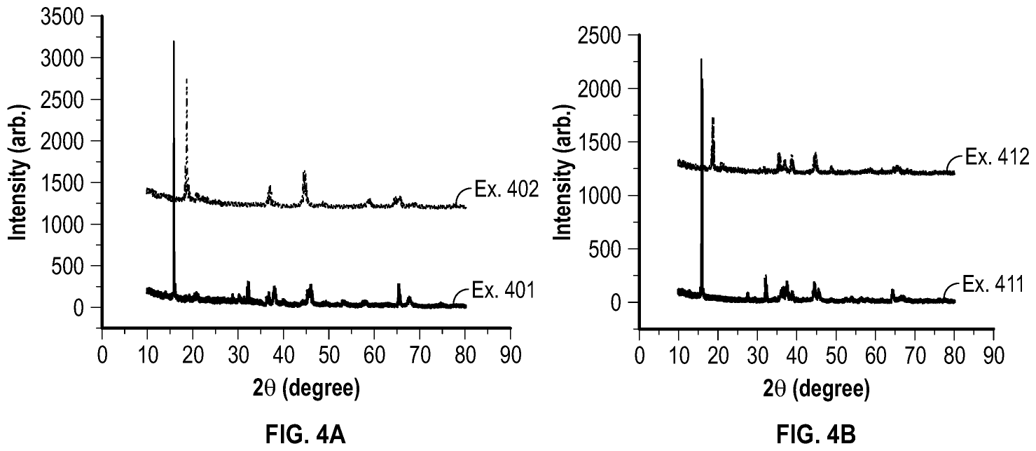

FIG. 4A shows exemplary PXRD patterns of an example P3-type sodium-containing manganese oxide (Na_{2/3}(Li_{1/6}Al_{1/6})Mn_{2/3}O₂; Example 401) and an example O3/T3-type lithium-containing manganese oxide formed after one ion-exchange reaction at 330° C. (Example 402). Example 402 has the formula Li_{(2/3-n)}Naₙ(Li_{1/6}Al_{1/6})Mn_{2/3}O₂, where n is about 0.06. For example, Na_{0.75}Li_{0.18}Al_{0.17}Mn_{0.76}O₂ for the Na phase and Li_{1.34}Na_{0.06}Al_{0.16}Mn_{0.81}O₂ after ion exchange.

FIG. 4B shows exemplary PXRD patterns of an example P3-type sodium-containing manganese oxide (Na_{2/3}Cu_{1/3}Mn_{2/3}O₂; Example 411) and an example O3/T3-type lithium-containing manganese oxide formed after one ion-exchange reaction at 330° C. (Ex. 412). Example 412 has the formula Li_{(2/3-n)}NaₙCu_{1/3}Mn_{2/3}O₂, where n is about 0.007. For example, Na_{0.65}Cu_{0.33}Mn_{0.65}O₂ for the Na phase and Li_{0.95}Na_{0.009}Cu_{0.34}Mn_{0.66}O₂ after ion exchange. The PXRD results shown in FIG. 4A and FIG. 4B indicate that the ion exchange reaction can be successfully achieved with different metal ions—Li⁺Al³⁺ and Cu²⁺—respectively.

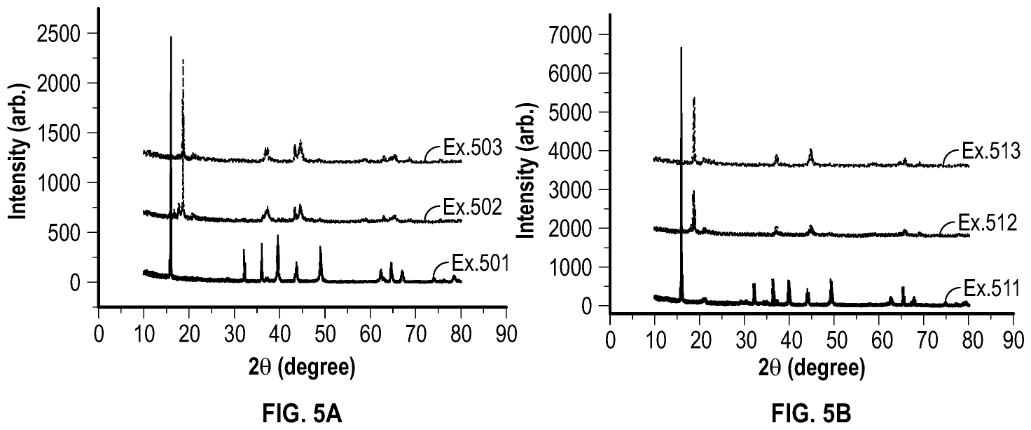

FIG. 5A shows exemplary PXRD patterns of example O2/T2-type lithium-containing manganese oxides formed by ion exchange reactions from an example P2-type sodium-containing manganese oxide (Na_{2/3}Ni_{1/3}Mn_{2/3}O₂; Example 501). Example 502 (formula: Li_{(2/3-n)}NaₙNi_{1/3}Mn_{2/3}O₂, where n is about 0.10) is the product formed after a first ion exchange reaction at 330° C., where there is residual of the original Na-phase maintained after this one time ion-exchange. Example 503 (formula: Li_{(2/3-n)}NaₙNi_{1/3}Mn_{2/3}O₂, where n is about 0.001) is the product formed after a second ion exchange reaction at 330° C., where no residual Na-phase is observed by PXRD, indicating the ion-exchange process is complete. For example, Na_{0.62}Ni_{0.33}Mn_{0.66}O₂ for the Na phase, Li_{0.70}Na_{0.10}Ni_{0.34}Mn_{0.67}O₂ after the first ion exchange and Li_{0.90}Na_{0.001}Ni_{0.36}Mn_{0.68}O₂ after the second ion exchange.

FIG. 5B shows exemplary PXRD patterns of example O2/T2-type lithium-containing manganese oxides formed by ion exchange reactions from an example O2/T2-type sodium-containing manganese oxide (Na_{2/3}(Li_{1/6}Al_{1/6})Mn_{2/3}O₂; Example 511). Example 512 (formula: Li_{(2/3-n)}Naₙ(Li_{1/6}Al_{1/6})Mn_{2/3}O₂, where n is about 0.09) is the product formed after a first ion exchange reaction at 330° C. Example 513 (formula: Li_{(2/3-n)}Naₙ(Li_{1/6}Al_{1/6})Mn_{2/3}O₂, where n is about 0.009) is the product formed after a second ion exchange reaction at 330° C. For example, Na_{0.72}Li_{0.17}Al_{0.18}Mn_{0.77}O₂ for the Na phase, Li_{1.35}Na_{0.09}Al_{0.19}Mn_{0.75}O₂ after the first ion exchange and Li_{1.36}Na_{0.01}Al_{0.18}Mn_{0.76}O₂ after the second ion exchange.

The PXRD results shown in FIG. 5A and FIG. 5B indicate that the ion exchange reaction can be successfully achieved from the P2-phase with different metal ions-Ni²⁺ and Li⁺Al³⁺-respectively. The PXRD results can also indicate that the Na⁺ ion in the P2-type sodium-containing manganese oxide has less mobility than that in the P3-type sodium-containing manganese oxide, and thereby can need two or more ion exchanges in order to remove the sodium.

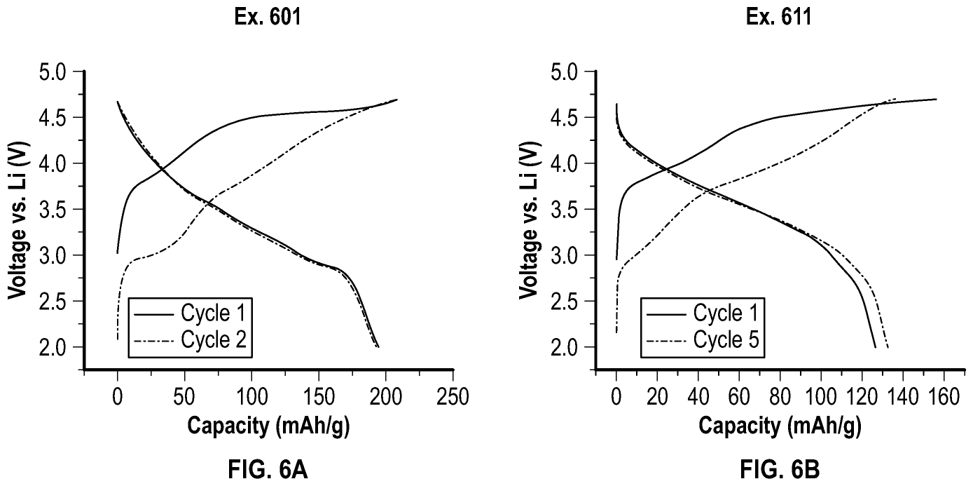

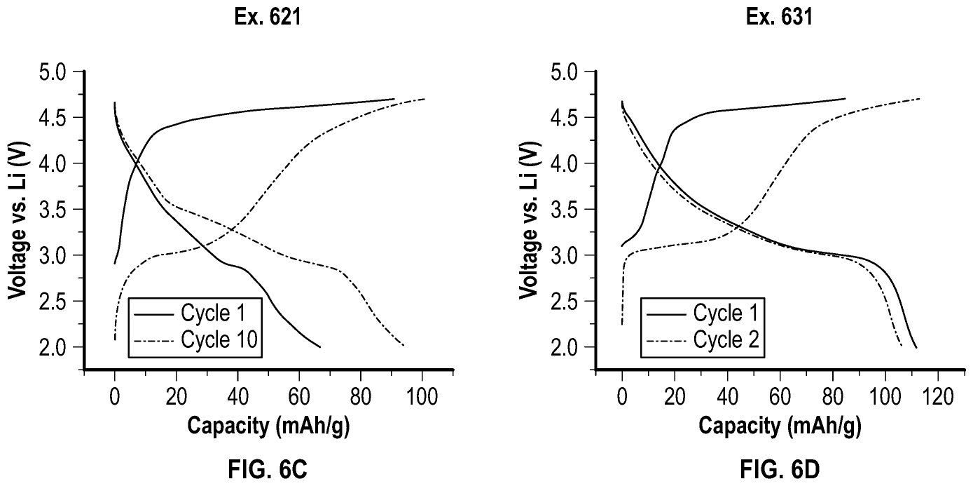

FIGS. 6A-6D shows galvanostatic charge and discharge data for example lithium-containing manganese oxides tested in Li half-cell configurations. The capacity is shown in milliampere hours per gram, mAh/g. The example lithium-containing manganese oxides tested are shown in Table 2. Table 2 also shows the temperature at which ion exchange was performed on the sodium-containing manganese oxides to form the lithium-containing manganese oxides.

TABLE 2

| | | Temperature of |
|---|---|---|
| | | ion exchange |
| Ex. # | Formula | reaction |
| 601 | Li_{(2/3-n)}NaₙNi_{1/3}Mn_{2/3}O₂, where n is about 0.03; | 250° C. |
| | O3 or T3-type | |
| 611 | Li_{(2/3-n)}NaₙNi_{1/3}Mn_{2/3}O₂, where n is about 0.006; | 330° C. |
| | O2 or T2-type | |
| 621 | Li_{(2/3-n)}NaₙNi_{1/3}Mn_{2/3}O₂, where n is about 0.006; | 330° C. |
| | O3 or T3-type | |
| 631 | Li_{(2/3-n)}Naₙ(Li_{1/6}Al_{1/6})Mn_{2/3}O₂, where n is about | 15° C.-25° C. |
| | 0.02; O3 or T3-type | |

The number of charge-discharge cycles tested for Ex. 601, Ex. 611, Ex. 621, and Ex. 631, were two, five, ten, and two, respectively. Under the conditions tested, Ex. 601 exhibited a cathode discharge capacity of about 195 mAh/g and a less than about 2% capacity loss at cycle 2 at a charge voltage of 4.7 V and discharge voltage 2.0 V. Under the conditions tested, Ex. 611 exhibited a cathode discharge capacity of about 132 mAh/g and a less than about 5% capacity loss at cycle 5 at a charge voltage of 4.7 V and discharge voltage 2.0 V. Under the conditions tested, Ex. 621 exhibited a cathode discharge capacity of about 66 mAh/g at cycle 1 and discharge capacity of about 94 mAh/g at cycle 10 at a charge voltage of 4.7 V and discharge voltage 2.0 V. Under the conditions tested, Ex. 631 exhibited a cathode capacity of about 111 mAh/g and a less than about 5% capacity loss at cycle 2 at a charge voltage of 4.7 V and discharge voltage 2.0 V. The data in FIGS. 6A-6D indicate that each of the lithium-containing manganese oxides show excellent extraction and insertion of Li⁺ even after multiple cycles. Conventional lithium-containing manganese oxides, such as LiNi_{1/3}Mn_{1/3}Co_{1/3}O₂, LiNi_{0.5}Mn_{0.3}Co_{0.2}O₂, and LiNi_{0.8}Mn_{0.1}Co_{0.1}O₂ have capacities of 170 mAh/g, 180 mAh/g, and 200 mAh/g, respectively. However, these conventional lithium-containing manganese oxides include cobalt.

Aspects described herein generally relate to manganese oxides that can be utilized as cathode active materials, cathodes comprising such materials, and energy storage devices containing such materials. Also described are processes of forming manganese oxides and cathode compositions. Overall, manganese oxides described herein can be utilized for cathodes of energy storage devices such as secondary batteries, including lithium-ion batteries and sodium-ion batteries. Relative to conventional technologies, the manganese oxides of the present disclosure can achieve a better overall balance of electrochemical performance properties when incorporated into energy storage devices, for example, an improved balance of battery cycle life, increased charge capacity, good cycle properties, and enhanced overall stability. Moreover, the manganese oxides can be produced cost-effectively than traditional technologies such as those containing cobalt.

### ASPECTS LISTING

The present disclosure provides, among others, the following aspects, each of which can be considered as optionally including any alternate aspects:

Clause 1. A cathode active material, comprising:
a composition comprising:
   a manganese oxide represented by Formula (I):

LiₐNa_{b}(M¹)_{c}Mn_{d}Oₑ (I),
a manganese oxide represented by Formula (II):

Na_{w}(M²)ₓMn_{y}O_{z} (II), or
combinations thereof, wherein:
   each of M¹ and M² is, individually, Ni, Cu, Zn, Mg, Fe, Co, Li, Al, Cr, LiAl, LiCr, LiCo, or combinations thereof;
   a, b, c, d, and e represent molar ratios of respective elements in Formula (I); and
   w, x, y, and z represent molar ratios of respective elements in Formula (II).

Clause 2. The cathode active material of Clause 1, wherein:
the manganese oxide represented by Formula (I) is a layered manganese oxide as determined by powder x-ray diffraction;
the manganese oxide represented by Formula (II) is a layered manganese oxide as determined by powder x-ray diffraction; or
combinations thereof.

Clause 3. The cathode active material of Clause 1 or Clause 2, wherein the manganese oxide represented by Formula (I) has a layered O2-type structure, a layered O3-type structure, a layered T2 type structure, a layered T3-type structure, or combinations thereof as determined by powder x-ray diffraction.

Clause 4. The cathode active material of any one of Clauses 1-3, wherein the manganese oxide represented by Formula (II) is a P2-type layered manganese oxide, a P3-type layered manganese oxide, or combinations thereof as determined by powder x-ray diffraction.

Clause 5. The cathode active material of any one of Clauses 1-4, wherein: a is from about 0.6 to about 0.8; b is from about 0 to about 0.7; c is from about 0.33 to about 0.4; d is from about 0.6 to about 0.67; and e is from about 1.95 to about 2.05.

Clause 6. The cathode active material of any one of Clauses 1-5, wherein: w is from about 0.67 to about 0.8; x is from about 0.33 to about 0.4; y is from about 0.6 to about 0.67; and z is from about 1.95 to about 2.05.

Clause 7. The cathode active material of any one of Clauses 1-6, wherein:
when the manganese oxide of Formula (I) is present, M¹ is Ni, Cu, or LiAl;
when the manganese oxide of Formula (II) is present, M² is Ni, Cu, or LiAl; or
combinations thereof.

Clause 8. A cathode, comprising: the cathode active material of any one of Clauses 1-7, a conductive agent, and optionally a binder.

Clause 9. A battery, comprising:
a first current collector;
a cathode disposed over at least a portion of the first current collector, the cathode comprising a composition, the composition comprising:
   a manganese oxide represented by Formula (I):

LiₐNa_{b}(M¹)_{c}Mn_{d}Oₑ (I),
a manganese oxide represented by Formula (II):

Na_{w}(M²)ₓMn_{y}O_{z} (II), or
combinations thereof, wherein:
   each of M¹ and M² is, individually, Ni, Cu, Zn, Mg, Fe, Co, Li, Al, Cr, LiAl, LiCr, LiCo, or combinations thereof;
   a, b, c, d, and e represent molar ratios of respective elements in Formula (I); and
   w, x, y, and z represent molar ratios of respective elements in Formula (II);
a separator disposed over at least a portion of the cathode;
an anode disposed over at least a portion of the separator; and
a second current collector disposed over at least a portion of the anode.

Clause 10. The battery of Clause 9, wherein, when the manganese oxide of Formula (I) is present: a is from about 0.6 to about 0.8; b is from about 0 to about 0.7; c is from about 0.33 to about 0.4; d is from about 0.6 to about 0.67; and e is from about 1.95 to about 2.05.

Clause 11. The battery of Clause 9 or Clause 10, wherein, when the manganese oxide of Formula (II) is present: w is from about 0.67 to about 0.8; x is from about 0.33 to about 0.4; y is from about 0.6 to about 0.67; and z is from about 1.95 to about 2.05.

Clause 12. An article, comprising:
a device; and
the battery of any one of Clauses 9-11 electrically coupled to the device.

Clause 13. The article of Clause 12, wherein the device is a component of a land vehicle, a bicycle, an aircraft, a watercraft, an amphibious vehicle, a spacecraft, a satellite, a light emitting diode, a consumer electronic, a wind turbine, a bridge, a building, a pipeline, or a smart grid.

Clause 14. A process for forming a manganese oxide, comprising:
introducing a sodium-containing precursor with a manganese-containing precursor and a metal-containing precursor under first conditions to form a mixture, the metal-containing precursor being different from the sodium-containing precursor and the manganese-containing precursor, the metal-containing precursor comprising Ni, Cu, Zn, Mg, Fe, Co, Li, Al, Cr, LiAl, LiCr, LiCo, or combinations thereof, and
heating the mixture under second conditions to form a composition comprising a manganese oxide represented by Formula (II):

Na_{w}(M²)ₓMn_{y}O_{z} (II),
wherein:
   M² is Ni, Cu, Zn, Mg, Fe, Co, Li, Al, Cr, LiAl, LiCr, LiCo, or combinations thereof; and
   w, x, y, and z represent molar ratios of respective elements in Formula (II).

Clause 15. The process of Clause 14, wherein, when the second conditions comprise an operating temperature of about 550° C. to about 750° C., the manganese oxide represented by Formula (I) present in the composition is characterized as being a substantially O3/T3-type structure as determined by powder x-ray diffraction.

Clause 16. The process of Clause 14 or Clause 15, wherein, when the second conditions comprise an operating temperature of about 750° C. to about 1,000° C., the manganese oxide represented by Formula (I) present in the composition is characterized as being a substantially 02/T2-type structure as determined by powder x-ray diffraction.

Clause 17. The process of any one of Clauses 14-16, further comprising performing an ion exchange reaction by reacting the manganese oxide represented by Formula (II) with a lithium-containing precursor under ion exchange conditions to form a composition comprising a manganese oxide represented by Formula (I):

LiₐNa_{b}(M¹)_{c}Mn_{d}Oₑ (I),
wherein, in Formula (I):
   M¹ is Ni, Cu, Zn, Mg, Fe, Co, Li, Al, Cr, LiAl, LiCr, LiCo, or combinations thereof, and
   a, b, c, d, and e represent molar ratios of respective elements.

Clause 18. The process of any one of Clauses 14-17, wherein the ion exchange conditions comprise an operating temperature of about 200° C. to about 500° C.

Clause 19. The process of any one of Clauses 14-18, wherein the ion exchange conditions comprise an operating temperature of about 15° C. to about 200° C.

Clause 20. The process of any one of Clauses 14-19, wherein the lithium-containing precursor comprises lithium hexafluorophosphate (LiPF₆), lithium nitrate (LiNO₃), lithium bromide (LiBr), lithium chloride (LiCl), lithium iodide (LiI), lithium hydroxide (LiOH), or combinations thereof.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

The use of headings is for purposes of convenience only and does not limit the scope of the present disclosure.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a nanotube” include aspects comprising one, two, or more nanotubes, unless specified to the contrary or the context clearly indicates only one nanotube is included. As another example, aspects comprising “a fiber” include aspects comprising one, two, or more fibers, unless specified to the contrary or the context clearly indicates only one fiber is included.

While the foregoing is directed to aspects of the present disclosure, other and further aspects of the disclosure may be devised without departing from the basic scope thereof, and the scope thereof is determined by the claims that follow.

What is claimed is:

1. A cathode active material, comprising:
a composition comprising:
a manganese oxide represented by Formula (I):
LiₐNa_{b}(M¹)_{c}Mn_{d}Oₑ (I),
a manganese oxide represented by Formula (II):
Na_{w}(M²)ₓMn_{y}O_{z} (II), or
combinations thereof, wherein:
each of M¹ and M² is, individually, Ni, Cu, Zn, Mg, Fe, Co, Li, Al, Cr, LiAl, LiCr, LiCo, or combinations thereof,
a, b, c, d, and e represent molar ratios of respective elements in Formula (I); and
w, x, y, and z represent molar ratios of respective elements in Formula (II).

2. The cathode active material of claim 1, wherein:
the manganese oxide represented by Formula (I) is a layered manganese oxide as determined by powder x-ray diffraction;
the manganese oxide represented by Formula (II) is a layered manganese oxide as determined by powder x-ray diffraction; or
combinations thereof.

3. The cathode active material of claim 1, wherein the manganese oxide represented by Formula (I) has a layered O2-type structure, a layered O3-type structure, a layered T2 type structure, a layered T3-type structure, or combinations thereof as determined by powder x-ray diffraction.

4. The cathode active material of claim 1, wherein the manganese oxide represented by Formula (II) is a P2-type layered manganese oxide, a P3-type layered manganese oxide, or combinations thereof as determined by powder x-ray diffraction.

5. The cathode active material of claim 1, wherein:
a is from about 0.6 to about 0.8;
b is from about 0 to about 0.7;
c is from about 0.33 to about 0.4;
d is from about 0.6 to about 0.67; and
e is from about 1.95 to about 2.05.

6. The cathode active material of claim 1, wherein:
w is from about 0.67 to about 0.8;
x is from about 0.33 to about 0.4;
y is from about 0.6 to about 0.67; and
z is from about 1.95 to about 2.05.

7. The cathode active material of claim 1, wherein:
when the manganese oxide of Formula (I) is present, M¹ is Ni, Cu, or LiAl;
when the manganese oxide of Formula (II) is present, M² is Ni, Cu, or LiAl; or
combinations thereof.

8. A cathode, comprising: the cathode active material of claim 1, a conductive agent, and optionally a binder.

9. A battery, comprising:
a first current collector;
a cathode disposed over at least a portion of the first current collector, the cathode comprising a composition, the composition comprising:
a manganese oxide represented by Formula (I):
LiₐNa_{b}(M¹)_{c}Mn_{d}Oₑ (I),
a manganese oxide represented by Formula (II):
Na_{w}(M²)ₓMn_{y}O_{z} (II), or
combinations thereof, wherein:
each of M¹ and M² is, individually, Ni, Cu, Zn, Mg, Fe, Co, Li, Al, Cr, LiAl, LiCr, LiCo, or combinations thereof,
a, b, c, d, and e represent molar ratios of respective elements in Formula (I); and
w, x, y, and z represent molar ratios of respective elements in Formula (II);
a separator disposed over at least a portion of the cathode;
an anode disposed over at least a portion of the separator; and
a second current collector disposed over at least a portion of the anode.

10. The battery of claim 9, wherein, when the manganese oxide of Formula (I) is present:
a is from about 0.6 to about 0.8;
b is from about 0 to about 0.7;
c is from about 0.33 to about 0.4;
d is from about 0.6 to about 0.67; and
e is from about 1.95 to about 2.05.

11. The battery of claim 9, wherein, when the manganese oxide of Formula (II) is present:
w is from about 0.67 to about 0.8;
x is from about 0.33 to about 0.4;
y is from about 0.6 to about 0.67; and
z is from about 1.95 to about 2.05.

12. An article, comprising:
a device; and
the battery of claim 9 electrically coupled to the device.

13. The article of claim 12, wherein the device is a component of a land vehicle, a bicycle, an aircraft, a watercraft, an amphibious vehicle, a spacecraft, a satellite, a light emitting diode, a consumer electronic, a wind turbine, a bridge, a building, a pipeline, or a smart grid.

14. A process for forming a manganese oxide, comprising:
introducing a sodium-containing precursor with a manganese-containing precursor and a metal-containing precursor under first conditions to form a mixture, the metal-containing precursor being different from the sodium-containing precursor and the manganese-containing precursor, the metal-containing precursor comprising Ni, Cu, Zn, Mg, Fe, Co, Li, Al, Cr, LiAl, LiCr, LiCo, or combinations thereof, and
heating the mixture under second conditions to form a composition comprising a manganese oxide represented by Formula (II):
Na_{w}(M²)ₓMn_{y}O_{z} (II),
wherein:
M² is Ni, Cu, Zn, Mg, Fe, Co, Li, Al, Cr, LiAl, LiCr, LiCo, or combinations thereof; and
w, x, y, and z represent molar ratios of respective elements in Formula (II).

15. The process of claim 14, wherein, when the second conditions comprise an operating temperature of about 550° C. to about 750° C., the manganese oxide represented by Formula (I) present in the composition is characterized as being a substantially O3/T3-type structure as determined by powder x-ray diffraction.

16. The process of claim 14, wherein, when the second conditions comprise an operating temperature of about 750° C. to about 1,000° C., the manganese oxide represented by Formula (I) present in the composition is characterized as being a substantially O2/T2-type structure as determined by powder x-ray diffraction.

17. The process of claim 14, further comprising:
performing an ion exchange reaction by reacting the manganese oxide represented by Formula (II) with a lithium-containing precursor under ion exchange conditions to form a composition comprising a manganese oxide represented by Formula (I):
LiₐNa_{b}(M¹)_{c}Mn_{d}Oₑ (I),
wherein:
M¹ is Ni, Cu, Zn, Mg, Fe, Co, Li, Al, Cr, LiAl, LiCr, LiCo, or combinations thereof; and
a, b, c, d, and e represent molar ratios of respective elements in Formula (I).

18. The process of claim 17, wherein the ion exchange conditions comprise an operating temperature of about 200° C. to about 500° C.

19. The process of claim 17, wherein the ion exchange conditions comprise an operating temperature of about 15° C. to about 200° C.

20. The process of claim 17, wherein the lithium-containing precursor comprises lithium hexafluorophosphate (LiPF₆), lithium nitrate (LiNO₃), lithium bromide (LiBr), lithium chloride (LiCl), lithium iodide (LiI), lithium hydroxide (LiOH), or combinations thereof.
